(19) United States
(12) Patent Application Publication
(10) Pub. No.: US 2018/0060521 A1
(43) Pub. Date: Mar. 1, 2018

(54) MANAGING CARE PATHWAYS

(71) Applicant: Cardiac Pacemakers, Inc., St. Paul, MN (US)

(72) Inventors: Patrick Connolly, Galway (IE); Timo Henrik Matias Lano, London (GB)

(21) Appl. No.: 15/688,689

(22) Filed: Aug. 28, 2017

Related U.S. Application Data
(60) Provisional application No. 62/380,635, filed on Aug. 29, 2016.

(51) Int. Cl. G06F 19/00

(52) U.S. Cl. CPC G06F 19/3418; G06F 19/326; G06F 19/3487

(57) ABSTRACT

A method of facilitating management of a care pathway includes receiving a care pathway definition, having a first care pathway step and a second care pathway step, where each care pathway step is identified by a unique identification (ID) code. The method includes determining a keyword associated with each care pathway step; and identifying, in patient information, care episodes. The method may include extracting, from the patient information, episode information corresponding to the care episodes; associating the care episodes with the corresponding care pathway steps; and determining, based on the care pathway definition and the episode information, a care metric. A display device may be used to present a representation of the care metric to a user.

### CROSS-REFERENCE TO RELATED APPLICATION

This application claims priority to Provisional Application No. 62/380,635, filed Aug. 29, 2016, which is herein incorporated by reference in its entirety.

### TECHNICAL FIELD

The present disclosure relates to systems and methods for facilitating management of care pathways. More specifically, the disclosure relates to systems and methods for determining, based on care pathways and patient information, care metrics.

### BACKGROUND

Costs for healthcare systems to monitor and treat patients with chronic conditions such as heart failure are significant and continue to rise. Accordingly, it is becoming more important for healthcare providers to develop strategies to increase efficiency and reduce costs while delivering high quality care with better patient outcomes. One such strategy includes developing standardized practices and reducing care variability, while providing care which is patient-centric. To enable this, providers may desire to identify root causes for problems in current systems of care and to find new ways of improving those systems. As such, providers and solutions designers may benefit from tools for analyzing, implementing, and improving care pathways, which may incorporate multiple care settings and care providers.

### SUMMARY

Embodiments include systems and methods that facilitate management of care pathways.

In an Example 1, a method of facilitating management of a care pathway, the method comprising: receiving a care pathway definition, the care pathway definition comprising a first care pathway step and a second care pathway step, wherein the first care pathway step is identified by a first step identification (ID) code, and wherein the second pathway step is identified by a second step ID code; determining a first keyword associated with the first care pathway step and a second keyword associated with the second care pathway step; receiving, from an information source, patient information associated with a patient; identifying, based on the first keyword and the patient information, a first care episode; identifying, based on the second keyword and the patient information, a second care episode; extracting, from the patient information, a first set of episode information corresponding to the first care episode and a second set of episode information corresponding to the second care episode; associating the first and second care episodes with the first and second care pathway steps, respectively; determining, based on the care pathway definition and the first and second sets of episode information, a care metric; and causing a display device to present a representation of the care metric.

In an Example 2, the method of Example 1, the patient information comprising clinical information and at least one of psychosocial information, experiential information, relational information, preferential information, demographic information, barrier information, and compliance information.

In an Example 3, the method of either of Examples 1 or 2, further comprising: receiving user input comprising an indication of a first weighting and an indication of a second weighting; and associating, based on the user input, the first and second weightings with the first and second care pathway steps, respectively.

In an Example 4, the method of any of Examples 1-3, further comprising generating, based on the care metric, a recommendation, the recommendation comprising at least one of a care recommendation and a care pathway definition recommendation.

In an Example 5, the method of Example 4, the recommendation comprising the care recommendation, wherein the care recommendation comprises a recommendation to associate the patient with a third care pathway step.

In an Example 6, the method of Example 4, the recommendation comprising the care pathway definition recommendation, wherein the care pathway recommendation comprises a suggested amended care pathway definition.

In an Example 7, the method of any of Examples 1-6, further comprising: determining that the first and second care episodes are linked; and associating a link identifier with each of the first and second care episodes, the link identifier indicating that the first and second care episodes are linked; wherein the care metric is determined based in part on the fact that the first and second care episodes are linked.

In an Example 8, the method of any of Examples 1-7, further comprising generating a report, the report comprising at least one of care pathway compliance information, care variability information, and financial information associated with the care pathway definition.

In an Example 9, a system for facilitating management of a care pathway, the system comprising: a display device; at least one processor; and one or more computer-readable media having computer-executable instructions embodied thereon that, when executed by the at least one processor, cause the at least one processor to instantiate at least one program component, the at least one program component comprising a care pathway manager configured to: receive a care pathway definition, the care pathway definition comprising a first care pathway step and a second care pathway step, wherein the first care pathway step is identified by a first step identification (ID) code, and wherein the second pathway step is identified by a second step ID code; identify, based on searching patient information for a first keyword associated with the first step ID code and a second keyword associated with the second step ID code, a first care episode and a second care episode, respectively; extract, from the patient information, a first set of episode information corresponding to the first care episode and a second set of episode information corresponding to the second care episode; associate the first and second care episodes with the first and second care pathway steps, respectively; determine, based on the care pathway definition and the first and second sets of episode information, a care metric; and cause the display device to present a representation of the care metric.

In an Example 10, the system of Example 9, the patient information comprising clinical information and at least one of psychosocial information, experiential information, relational information, preferential information, demographic information, barrier information, and compliance information.

In an Example 11, the system of either of Examples 9 or 10, wherein the care pathway manager is further configured to: receive user input comprising an indication of a first weighting and an indication of a second weighting; and associate, based on the user input, the first and second weightings with the first and second care pathway steps, respectively.

In an Example 12, the system of any of Examples 9-11, wherein the care pathway manager is further configured to generate, based on the care metric, a recommendation, the recommendation comprising at least one of a care recommendation and a care pathway definition recommendation.

In an Example 13, the system of Example 12, the recommendation comprising the care recommendation, wherein the care recommendation comprises a recommendation to associate the patient with a third care pathway step.

In an Example 14, the system of Example 12, the recommendation comprising the care pathway definition recommendation, wherein the care pathway recommendation comprises a suggested amended care pathway definition.

In an Example 15, the system of any of Examples 9-14, wherein the care pathway manager is further configured to: determine that the first and second care episodes are linked; and associate a link identifier with each of the first and second care episodes, the link identifier indicating that the first and second care episodes are linked; wherein the care metric is determined based in part on the fact that the first and second care episodes are linked.

In an Example 16, a method of facilitating management of a care pathway, the method comprising: receiving user input comprising a first step identification (ID) code and a second step ID code, the first step ID code corresponding to a first care pathway step and the second step ID code corresponding to a second care pathway step; constructing a care pathway structure based on the first and second care pathway steps; determining a first keyword associated with the first care pathway step and a second keyword associated with the second care pathway step; receiving, from an information source, patient information associated with a patient; identifying, based on the first keyword and the patient information, a first care episode; identifying, based on the second keyword and the patient information, a second care episode; extracting, from the patient information, a first set of episode information corresponding to the first care episode and a second set of episode information corresponding to the second care episode; associating the first and second care episodes with the first and second care pathway steps, respectively; determining, based on the care pathway definition and the first and second sets of episode information, a care metric; and causing a display device to present a representation of the care metric.

In an Example 17, the method of Example 16, the patient information comprising clinical information and at least one of psychosocial information, experiential information, relational information, preferential information, demographic information, barrier information, and compliance information.

In an Example 18, the method of Example 16, further comprising generating, based on the care metric, a recommendation, the recommendation comprising at least one of a care recommendation and a care pathway definition recommendation.

In an Example 19, the method of Example 18, further comprising: determining that the first and second care episodes are linked; and associating a link identifier with each of the first and second care episodes, the link identifier indicating that the first and second care episodes are linked; wherein the care metric is determined based in part on the fact that the first and second care episodes are linked.

In an Example 20, the method of Example 19, the recommendation comprising the care recommendation, wherein the care recommendation comprises a recommendation to associate the patient with a third care pathway step.

In an Example 21, the method of Example 20, further comprising: receiving user input comprising an indication of a first weighting and an indication of a second weighting; and associating, based on the user input, the first weighting with a third care pathway step; and associating, based on the user input, the second weighting with a fourth care pathway step; wherein generating the care recommendation comprises determining that the first weighting is greater than the second weighting.

In an Example 22, the method of Example 18, the recommendation comprising the care pathway definition recommendation, wherein the care pathway recommendation comprises a suggested amended care pathway definition.

In an Example 23, the method of Example 16, further comprising generating a report, the report comprising at least one of care pathway compliance information, care variability information, and financial information associated with the care pathway definition.

In an Example 24, a system for facilitating management of a care pathway, the system comprising: a display device; at least one processor; and one or more computer-readable media having computer-executable instructions embodied thereon that, when executed by the at least one processor, cause the at least one processor to instantiate at least one program component, the at least one program component comprising a care pathway manager configured to: receive a care pathway definition, the care pathway definition comprising a first care pathway step and a second care pathway step, wherein the first care pathway step is identified by a first step identification (ID) code, and wherein the second pathway step is identified by a second step ID code; identify, based on searching patient information for a first keyword associated with the first step ID code and a second keyword associated with the second step ID code, a first care episode and a second care episode, respectively; extract, from the patient information, a first set of episode information corresponding to the first care episode and a second set of episode information corresponding to the second care episode; associate the first and second care episodes with the first and second care pathway steps, respectively; determine, based on the care pathway definition and the first and second sets of episode information, a care metric; and cause the display device to present a representation of the care metric.

In an Example 25, the system of Example 24, the patient information comprising clinical information and at least one of psychosocial information, experiential information, relational information, preferential information, demographic information, barrier information, and compliance information.

In an Example 26, the system of Example 24, wherein the care pathway manager is further configured to generate, based on the care metric, a recommendation, the recommendation comprising at least one of a care recommendation and a care pathway definition recommendation.

In an Example 27, the system of Example 26, the recommendation comprising the care recommendation, wherein the care recommendation comprises a recommendation to associate the patient with a third care pathway step.

In an Example 28, the system of Example 27, wherein the care pathway manager is further configured to: determine that the first and second care episodes are linked; and associate a link identifier with each of the first and second care episodes, the link identifier indicating that the first and second care episodes are linked; wherein the care metric is determined based in part on the fact that the first and second care episodes are linked.

In an Example 29, the system of Example 27, wherein the care pathway manager is further configured to: receive user input comprising an indication of a first weighting and an indication of a second weighting; and associate, based on the user input, the first weighting with a third care pathway step; and associate, based on the user input, the second weighting with a fourth care pathway step; wherein the care pathway manager generates the care recommendation in part by determining that the first weighting is greater than the second weighting.

In an Example 30, the system of Example 26, the recommendation comprising the care pathway definition recommendation, wherein the care pathway recommendation comprises a suggested amended care pathway definition.

In an Example 31, a method of facilitating management of a care pathway, the method comprising: receiving a first stage identification (ID) code and a second stage ID code, the first stage ID code corresponding to a first care pathway stage and the second stage ID code corresponding to a second care pathway stage; receiving a first step ID code and a second step ID code, the first step ID code corresponding to a first care pathway step and the second step ID code corresponding to a second care pathway step; constructing a care pathway structure by: establishing a care pathway trajectory defining an intended chronological order associated with the first and second care pathway stages; associating the first care pathway step with the first care pathway stage; and associating the second care pathway step with the second care pathway stage; determining a first keyword associated with the first care pathway step and a second keyword associated with the second care pathway step; receiving, from an information source, patient information associated with a patient; identifying, based on the first keyword and the patient information, a first care episode; associating a first care episode code with the first care episode; identifying, based on the second keyword and the patient information, a second care episode; associating a second care episode code with the second care episode; extracting, from the patient information, a first set of episode information corresponding to the first care episode and a second set of episode information corresponding to the second care episode; associating the first and second care episodes with the first and second care pathway steps, respectively; determining, based on the care pathway definition and the first and second sets of episode information, a care metric; and causing a display device to present a representation of the care metric.

In an Example 32, the method of Example 31, further comprising: generating an episode timeline that indicates a temporal relationship between the first care episode and the second care episode; determine that the first and second care episodes are linked; and associate a link identifier with each of the first and second care episodes, the link identifier indicating that the first and second care episodes are linked; wherein the care metric is determined based in part on the episode timeline and the fact that the first and second care episodes are linked.

In an Example 33, the method of Example 31, further comprising generating, based on the care metric, a recommendation, the recommendation comprising at least one of a care recommendation and a care pathway definition recommendation.

In an Example 34, the method of Example 33, the recommendation comprising the care recommendation, wherein the care recommendation comprises a recommendation to associate the patient with a third care pathway step, the method further comprising: receiving user input comprising an indication of a first weighting and an indication of a second weighting; and associating, based on the user input, the first weighting with a third care pathway step; and associating, based on the user input, the second weighting with a fourth care pathway step; wherein generating the care recommendation comprises determining that the first weighting is greater than the second weighting.

In an Example 35, the method of Example 33, the recommendation comprising the care pathway definition recommendation, wherein the care pathway recommendation comprises a suggested amended care pathway definition.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 is a block diagram depicting an illustrative system 100 for facilitating management of a care pathway, in accordance with embodiments of the disclosure.

FIG. 2 is a block diagram depicting an illustrative computing device 200, in accordance with embodiments of the disclosure.

FIG. 3 is a block diagram depicting an illustrative system 300 for facilitating management of a care pathway, in accordance with embodiments of the disclosure.

FIG. 4 is a block schematic diagram depicting an illustrative representation of a care pathway structure, in accordance with embodiments of the disclosure.

FIG. 5 is a block schematic diagram depicting an illustrative representation of a care pathway definition, in accordance with embodiments of the disclosure.

FIG. 6 is an illustrative graph depicting an example of a timeline of symptoms presented on a dashboard, in accordance with embodiments of the disclosure.

FIG. 7 is a flow diagram depicting an illustrative method of facilitating management of a care pathway, in accordance with embodiments of the disclosure.

FIGS. 8A-8F depict illustrative representations of care metrics, in accordance with embodiments of the disclosure.

FIG. 9 is a block schematic diagram depicting an illustrative process for facilitating management of a care pathway, in accordance with embodiments of the disclosure.

While the disclosed subject matter is amenable to various modifications and alternative forms, specific embodiments have been shown by way of example in the drawings and are described in detail below. The intention, however, is not to limit the disclosed subject matter to the particular embodiments described. On the contrary, the disclosure is intended to cover all modifications, equivalents, and alternatives falling within the scope of the disclosed subject matter as defined by the appended claims.

As the terms are used herein with respect to ranges of measurements (such as those disclosed immediately above), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error, differences in measurement and/or manufacturing equipment calibration, human error in reading and/or setting measurements, adjustments made to optimize performance and/or structural parameters in view of differences in measurements associated with other components, particular implementation scenarios, imprecise adjustment and/or manipulation of objects by a person or machine, and/or the like.

Although the term “block” may be used herein to connote different elements illustratively employed, the term should not be interpreted as implying any requirement of, or particular order among or between, various blocks disclosed herein. Similarly, although illustrative methods may be represented by one or more drawings (e.g., flow diagrams, communication flows, etc.), the drawings should not be interpreted as implying any requirement of, or particular order among or between, various steps disclosed herein. Additionally, a “set,” “subset,” or “group” of items (e.g., inputs, algorithms, data values, etc.) may include one or more items, and, similarly, a subset or subgroup of items may include one or more items. A “plurality” means more than one.

### DETAILED DESCRIPTION

Embodiments include health management systems and methods that facilitate patient health management, prevention of patient health deterioration, prevention of patient adverse events, patient care planning and execution, and/or the like. Embodiments include a health management system configured to manage care pathways, which may include, for example, generating care pathways, modifying care pathways, analyzing compliance with care pathways, and/or the like. Care pathways include any number of different maps, plans, and/or other characterizations associated with a patient's illness or condition. In embodiments, for example, a care pathway may include a set of steps associated with a patient's disease process and may include, for example, symptomology stages, clinical episodes, diagnosis, treatment steps, and/or the like. A care pathway may be patient-specific, designed for a patient population, or a combination thereof. That is, for example, general care pathways may be designed for certain groups of patients (e.g., patients with a particular type of illness or condition, patients with certain demographics, and/or the like), and may be modified for particular patients. Additionally, embodiments may include establishing or amending care pathways for certain patient populations based on patient-specific information (or aggregations of patient-specific information for a population of patients), establishing or amending established patient-specific care pathways based on general care pathways, and/or the like.

Conventional care pathway management systems typically manage care pathways based on clinical information and varying syntax and semantic constructs, but those systems generally are not configured to standardize information, efficiently index information based on standardized indexing codes, or incorporate other types of patient information such as, for example, psychosocial information, experiential information, relational information, preferential information, demographic information, cultural information, and/or the like. Embodiments of the health management system described herein incorporate these indexing strategies and types of information, which may facilitate more flexible and robust management of care pathways.

Embodiments of the disclosure may be implemented as systems, tools, applications, and/or software configured to analyze variance in healthcare treatment practices across a care pathway or multiple care pathways by identifying, structuring and analyzing specific data found in patient electronic health records (EHRs), emergency department attendance records or any other type of patient information. Embodiments of the systems and methods described herein may facilitate determining the care pathway that a patient or group of patients travel or traveled and comparing the traveled pathway or actual patient experience with a pre-defined, guideline-based care pathway. Examples of other information that can be extracted, analyzed, reported, and/or visualized by embodiments of the systems described herein, using graphical representations, include statistics associated with the number of times patients present with signs and symptoms; the number of times patients will present with signs and symptoms before any assessments are conducted in accordance with a particular care pathway; the length of time from first presentation with symptoms to diagnosis; the increase in symptom reporting as a patients become refractory to the medication they are prescribed; the length of time before patients are referred to a specialist for evaluation for a medical device treatment (e.g., ablation, PVI, pacemaker, occlusion device, etc.); the number of reports of certain trigger events prior to the occurrence of a more significant event (e.g., a stroke or heart attack); the tendency for specific doctors to refer patients to other specialists; the number of times tests are not followed-up on; and/or the like.

Embodiments of the health management system also incorporate access to different databases or repositories containing different types of information, thereby facilitating increasingly accurate care pathway management that may take into account numerous aspects of a patient's condition, situation, preferences, values, culture, behaviors, and/or the like. For example, the health management system may receive information from one or more information sources that provide a patient's clinical information such as, for example, an electronic health record (EHR) system, and/or a personal health record (PHR) system. The system also may receive information from a Patient Relationship Management (PRM) system, which provides other types of information that may facilitate understanding an individual patient's care trajectory, challenges, and risks and various factors that contribute thereto. For example, the PRM system may provide psychosocial information, experiential information, relational information, preferential information, demographic information, cultural information, and/or the like. Embodiments of the PRM system may be used for documenting, planning and facilitating patient care episodes and/or patient interactions. For example, the PRM system (which may, in embodiments, be integrated with the health management system) may provide a PRM dashboard configured to present patient information, information about past interactions, previous efforts to follow-up on or reach out to a patient, and/or the like.

Embodiments of the health management system may facilitate user access to information from systems such as the EHR, PHR, and PRM systems by providing interfaces to those systems, by providing a query service that access those systems, by integrating those systems within the health management system, and/or the like. Embodiments of the health management system may implement guidelines and/or algorithms that enable it to provide healthcare providers with recommendations and/or prompts (health planning recommendations) to facilitate assembly of an appropriate patient care team and care pathway based on calculated care metrics. Care metrics may include any number of different types of information resulting from analyses of patient information and care pathways. For example, care metrics may include metrics associated with compliance (e.g., metrics that characterize compliance with a care pathway), metrics associated with care quality, metrics that represent aggregated information about certain doctors, etc.). Embodiments may facilitate prioritization of treatment for patients and/or symptoms, thereby enabling workflow efficiencies.

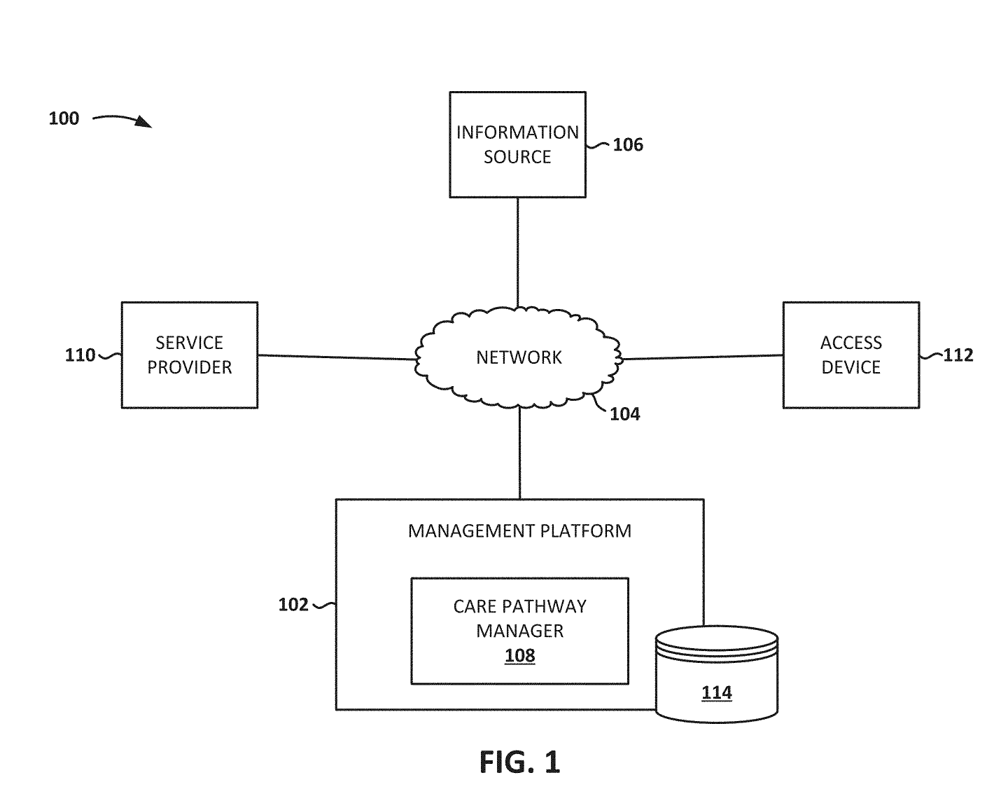

FIG. 1 is a block diagram depicting an illustrative system 100 for facilitating management of care pathways, in accordance with embodiments of the disclosure. As shown in FIG. 1, the illustrative health management system 100 includes a management platform 102 that accesses patient information, via a network 104, from an information source 106. The network 104 may be, or include, any number of different types of communication networks such as, for example, a short messaging service (SMS), a local area network (LAN), a wireless LAN (WLAN), a virtual LAN (VLAN), a wide area network (WAN), the Internet, a peer-to-peer (P2P) network, custom-designed communication or messaging protocols, and/or the like. The network 104 may include a combination of multiple networks. The information source 106 may include, for example, the Internet, an email provider, a website, an electronic health record (EHR), a patient relationship management (PRM) database, a user interface, and/or the like. According to embodiments, the management platform 102 implements a care pathway manager 108 that uses the accessed information to generate, update, and analyze care pathways associated with patients. The care pathway manager 108 may use the accessed information to determine any number of different care metrics which may, in embodiments, represent care pathway compliance, various aspects of care variability, financial aspects of a care pathway, and/or the like. The management platform 102 may use the care metrics to facilitate any number of health-management related services such as, for example, by providing access to the care metrics and related information, and/or by utilizing a service provider 110, which a consumer of the services may access with an access device 112. Although depicted as a single component solely for the purposes of clarity of description, the access device 112 may actually refer to more than one access device 112.

The management platform 102, the information source 106, and/or the service provider 110 may be implemented using one or more servers, which may be, include, or may be included in, a computing device that includes one or more processors and a memory. The one or more servers, and/or any one or more components thereof, may be implemented in a single server instance, multiple server instances (e.g., as a server cluster), distributed across multiple computing devices, instantiated within multiple virtual machines, implemented using virtualized components such as virtualized processors and memory, and/or the like. According to embodiments, the management platform 102 may be referred to as a care management platform or care coordination platform.

The care path manager 108 obtains, copies, or otherwise accesses patient information from the information source 106. Although depicted as a single component solely for the purposes of clarity of description, the information source 106 may actually refer to more than one information source 106. The care path manager 108 may store the patient information, portions of the patient information, and/or information extracted from the patient information in a database 114. The database 114, which may refer to one or more databases, may be, or include, one or more tables, one or more relational databases, one or more multi-dimensional data cubes, and the like. Further, though illustrated as a single component, the database 114 may, in fact, be a plurality of databases 114 such as, for instance, a database cluster, which may be implemented on a single computing device or distributed between a number of computing devices, memory components, or the like.

In operation, the care path manager 108 accesses patient information (e.g., from the database 114, the information source 106, and/or the like) and, based on the patient information, generates a care pathway definition associated with a patient. The care path manager 108 may analyze patient information and, based on the patient information and a care pathway definition, determine one or more care metrics. As used herein, the term “based on” is not meant to be restrictive, but rather indicates that a determination, identification, prediction, calculation, or the like, is performed by using, at least, the term following “based on” as an input. For example, a care path manager 108 that determines a care metric based on a particular piece of information may additionally, or alternatively, base the same determination on another piece of information.

In embodiments, the care path manager 108 determines a care metric based on a number of different types of patient information. In addition to using EHR information and PRM information, embodiments of the care path manager 108 may use various user inputs in determining a care metric. For example, a user (e.g., a patient, a caregiver, an insurer, etc.) may want to obtain a care metric associated with a care pathway, and may do so by providing a query to the health management system 100 as an input. Care metrics may include any number of different types of information resulting from analyses of patient information and care pathways.

For example, embodiments of the care path manager 108 may be configured to analyze a care provider's adherence to a defined care pathway. Embodiments of the care path manager 108 may be configured to determine where care pathways are breaking down, why patients are not traveling recommended care pathways, and/or why patients are not being treated in accordance with a defined care pathway. In embodiments, the care path manager 108 may be configured to measure amounts of variability occurring in care and identify where higher levels of variability occur and what caregivers are responsible for various levels of care variability. Embodiments of the care path manager 108 may be configured to conduct root cause analyses for healthcare providers via healthcare data analytics to determine where errors occur or where gaps or issues exist along a single or along multiple care pathways.

In embodiments, care pathways extend across multiple sites of care including acute, hospital or secondary care, primary care, community, home care and tertiary care. The care path manager 108 may be configured to conduct variance analysis across all sites of care involved in a care pathway. In this manner, embodiments of the care path manager 108 may be configured to identify issues with care transitions from one care provider to another and/or from one care setting to another. In embodiments, the care path manager 108 may also be configured to identify patients present within a health system or within different care settings that may have a certain disease or condition and may or may not have been diagnosed. Embodiments of the care path manager 108 may facilitate notifying or informing providers within a healthcare network about a patient and about recent or past episodes of care involving this patient. According to embodiments, the care path manager 108 may be configured to identify repeated episodes of care and, in some cases, these repeated episodes may have been unnecessary or avoidable. In this manner, embodiments of the care path manager 108 can facilitate identifying waste occurring during the execution of a care pathway and the cost of this waste.

In embodiments, the care pathways, care metrics, and/or the like, may be used to facilitate one or more services. Aspects of the services may be provided using the management platform 102 and/or the service provider 110 which may include, for example, applications, service functions, or the like, that provide services for facilitating management of care pathways. In embodiments, the service provider 110 may refer to one or more service providers 110 any one or more of which (and/or components thereof) may be integrated with the management platform 102. In embodiments, the services may include presenting risk scores and risk score information to users; providing care pathway recommendations (e.g., suggestions to amend general and/or patient-specific care pathways based on patient-specific information and/or aggregated information); generating care pathways; identifying appropriate members of a care team; providing notifications of certain events and/or care episodes to members of a care team; simulating care pathway scenarios; providing financial information associated with care pathways; evaluating care provider performance; and/or the like.

Embodiments of the management platform 102 and/or the service provider 110 may facilitate conducting healthcare simulations. For example, in embodiments, a user can create and provide as input imaginary and/or random patient data to see how the treatment of fictitious patients compares to a recommended treatment pathway. Similarly, in embodiments, a user could provide as an input the definition of a new proposed or fictitious care pathway and compare existing treatment against that proposed or fictitious pathway. In this manner, embodiments of the system 100 may facilitate estimating resources or budget (e.g., using financial modelling) implicated by a new proposed care pathway or a modification to an existing care pathway.

Embodiments of the management platform 102 and/or the service provider 110 may be configured to provide clinical decision support or recommendations for changes to existing practices. For example, in embodiments, a service may include providing a recommendation to a provider about what next care pathway steps should be implemented for a patient. In embodiments, the management platform 102 and/or the service provider 110 may be used to evaluate the effectiveness of treatment and may be used for pilot studies or clinical trials. For example, it may be helpful to know if a patient followed a preferred care pathway prior to and/or after receiving a particular treatment where the treatment may be a procedure involving a medical device, a course of medication or a surgical procedure; all of which could be undergoing evaluation as part of a clinical trial.

Various components depicted in FIG. 1 may operate together to form the health management system 100, which may be, for example, a computerized patient management and monitoring system. In embodiments, the system 100 may be designed to assist in monitoring the patient's condition, managing the patient's therapy, and/or the like. Patient health management and monitoring systems can provide large amounts of data about patients to users such as, for example, clinicians, patients, researchers, and/or the like. According to embodiments, the management platform 102 may additionally, or alternatively, be configured to provide reports to access devices 112, manage patient information, configure therapy regimens, manage/update device software, and/or the like.

The management platform 102 may be configured to perform security functions, verification functions, and/or the like. Due to potential risks associated with inaccurate calculation of risk scores and recommendations generated based thereon, it may be desirable for aspects of an at least partially automated system 100 to include safeguards such as, for example, verification of calculations, clinician oversight, and/or the like. For example, some types of users may be permitted, by the management platform 102, to have access to different amounts and/or types of information than other users. In embodiments, the management platform 102 may facilitate maintaining user profiles so that a user's role can be verified, thereby enabling the management platform 102 to customize the information available to a user. That is, for instance, an insurer may only be permitted to access certain portions of an EHR, PHR, PRM database, risk score, and/or the like, whereas a member of a patient's care team may be permitted to access more information.

In embodiments, the health management system 100 may be configured so that various components of the health management system 100 provide reporting to various individuals (e.g., patients and/or clinicians). For example, in embodiments, a user interface can be accessed via a device that is portable such that the user can use the system and have access to the system as they move about within a hospital. In addition to forms of reporting including visual and/or audible information, the system 100 may also communicate with and/or reconfigure medical devices, which may be examples of information sources 106 and/or access devices 112. For example, if an access device 112 is part of a cardiac rhythm management system, the management platform 102 may communicate with the device 112 and reconfigure the therapy provided by the cardiac rhythm management system based on the patient information. In another embodiment, the management platform 102 may provide, to the access device 112, recorded information, an ideal range for the information, a conclusion based on the information, a recommended course of action, and/or the like. This information may be displayed using a display device associated with the access device 112 for the patient to review or made available for the patient and/or clinician to review.

A variety of communication methods and protocols may be used to facilitate communication between management platforms 102, information sources 106, service providers 110, and/or access devices 112. For example, wired and wireless communications methods may be used. Wired communication methods may include, for example and without limitation, traditional copper-line communications such as DSL, broadband technologies such as ISDN and cable modems, and fiber optics, while wireless communications may include cellular, satellite, radio frequency (RF), Infrared, and/or the like.

For any given communication method, a multitude of standard and/or proprietary communication protocols may be used. For example and without limitation, protocols such as radio frequency pulse coding, spread spectrum, direct sequence, time-hopping, frequency hopping, SMTP, FTP, and TCP/IP may be used. Other proprietary methods and protocols may also be used. Further, a combination of two or more of the communication methods and protocols may also be used.

The various communications between the components of the system 100 may be made secure using several different techniques. For example, encryption and/or tunneling techniques may be used to protect data transmissions. Alternatively, a priority data exchange format and interface that are kept confidential may also be used. Authentication may be implemented using, for example, digital signatures based on a known key structure (e.g., PGP or RSA). Other physical security and authentication measures may also be used, such as security cards and biometric security apparatuses (e.g., retina scans, iris scans, fingerprint scans, vein-print scans, voice, facial geometry recognition, etc.). Conventional security methods such as firewalls may be used to protect information residing on one or more of the storage media of the advanced patient management system 100. Encryption, authentication and verification techniques may also be used to detect and correct data transmission errors.

In embodiments, varying levels of security may be applied to communications depending on the type of information being transmitted. For example, in embodiments, the management platform 102 (or other device) may be configured to apply stricter security measures to confidential health care information than to demographic information. Similarly, even more security may be applied to communications of information used for controlling therapy, adjudicating episodes, and/or the like. In embodiments, varying levels of security may be applied to communications depending on the type of user to whom the information is being communicated. Additionally, in embodiments, communications among the various components of the system 100 may be enhanced using compression techniques to allow large amounts of data to be transmitted efficiently.

The illustrative health management system 100 shown in FIG. 1 is not intended to suggest any limitation as to the scope of use or functionality of embodiments of the present disclosure. Neither should the illustrative system 100 be interpreted as having any dependency or requirement related to any single component or combination of components illustrated therein. Additionally, various components depicted in FIG. 1 may be, in embodiments, integrated with various ones of the other components depicted therein (and/or components not illustrated), all of which are considered to be within the ambit of the present disclosure.

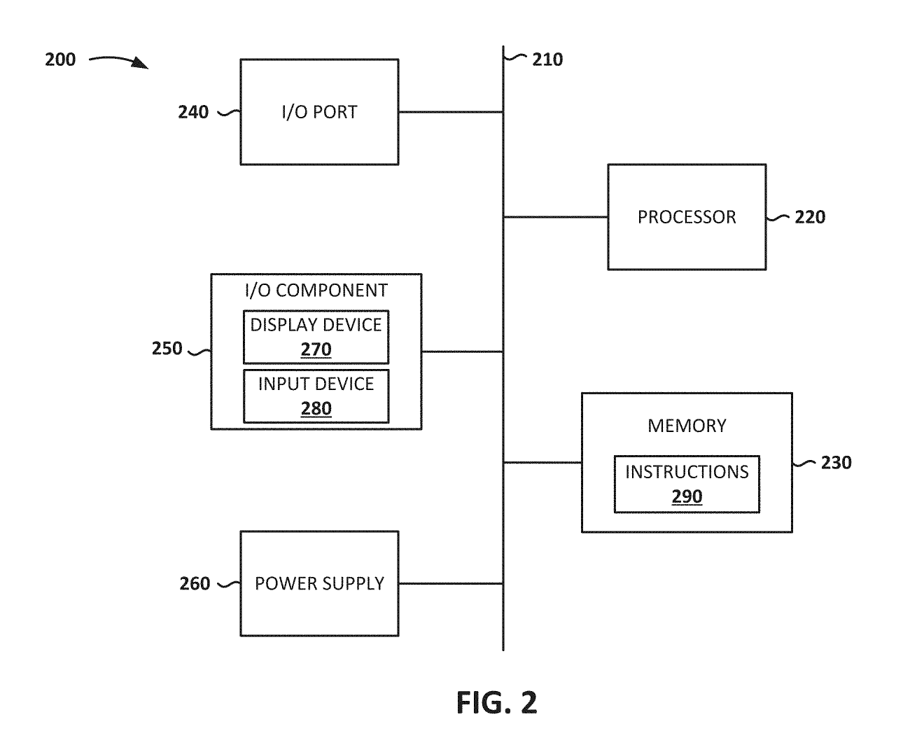

According to various embodiments of the disclosed subject matter, any number of the components depicted in FIG. 1 (e.g., the management platform 102, the information source 106, the service provider 110, and/or the access device 112) may be implemented on one or more computing devices. FIG. 2 is a block diagram depicting an illustrative computing device 200, in accordance with embodiments of the disclosure. The computing device 200 may include any type of computing device suitable for implementing aspects of embodiments of the disclosed subject matter. Examples of computing devices include specialized computing devices or general-purpose computing devices such “workstations,” “servers,” “laptops,” “desktops,” “tablet computers,” “hand-held devices,” “general-purpose graphics processing units (GPGPUs),” and the like, all of which are contemplated within the scope of FIGS. 1 and 2, with reference to various components of the system 100 and/or computing device 200.

In embodiments, the computing device 200 includes a bus 210 that, directly and/or indirectly, couples the following devices: a processor 220, a memory 230, an input/output (I/O) port 240, an I/O component 250, and a power supply 260. Any number of additional components, different components, and/or combinations of components may also be included in the computing device 200. The I/O component 250 may include a presentation component configured to present information to a user such as, for example, a display device 270, a speaker, a printing device, and/or the like, and/or an input device 280 such as, for example, a microphone, a joystick, a satellite dish, a scanner, a printer, a wireless device, a keyboard, a pen, a voice input device, a touch input device, a touch-screen device, an interactive display device, a mouse, and/or the like.

The bus 210 represents what may be one or more busses (such as, for example, an address bus, data bus, or combination thereof). Similarly, in embodiments, the computing device 200 may include a number of processors 220, a number of memory components 230, a number of I/O ports 240, a number of I/O components 250, and/or a number of power supplies 260. Additionally any number of these components, or combinations thereof, may be distributed and/or duplicated across a number of computing devices.

In embodiments, the memory 230 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like. In embodiments, the memory 230 stores computer-executable instructions 290 for causing the processor 220 to implement aspects of embodiments of system components discussed herein and/or to perform aspects of embodiments of methods and procedures discussed herein.

The computer-executable instructions 290 may include, for example, computer code, machine-useable instructions, and the like such as, for example, program components capable of being executed by one or more processors 220 associated with the computing device 200. Program components may be programmed using any number of different programming environments, including various languages, development kits, frameworks, and/or the like. Some or all of the functionality contemplated herein may also, or alternatively, be implemented in hardware and/or firmware.

The illustrative computing device 200 shown in FIG. 2 is not intended to suggest any limitation as to the scope of use or functionality of embodiments of the present disclosure. Neither should the illustrative computing device 200 be interpreted as having any dependency or requirement related to any single component or combination of components illustrated therein. Additionally, various components depicted in FIG. 2 may be, in embodiments, integrated with various ones of the other components depicted therein (and/or components not illustrated), all of which are considered to be within the ambit of the present disclosure.

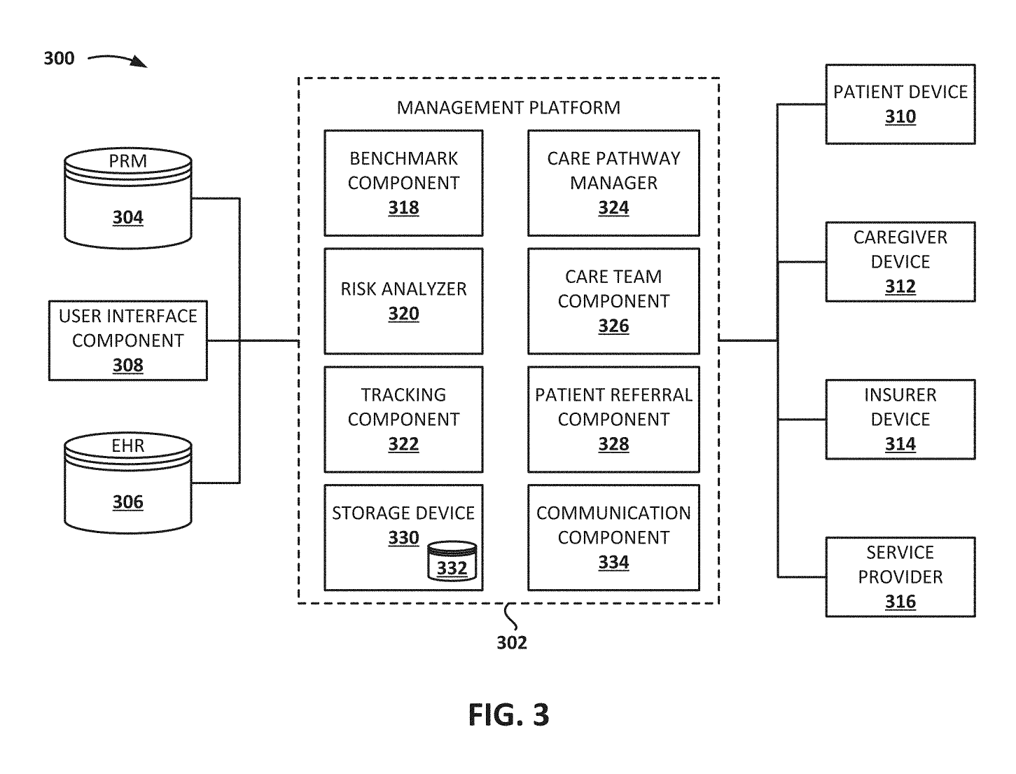

FIG. 3 is another block diagram depicting an illustrative health management system 300, in accordance with embodiments of the disclosure. As shown, the system 300 includes a management platform 302 (e.g., the management platform 102 depicted in FIG. 1) that is communicably coupled to information sources such as, e.g., a PRM database 304, an EHR database 306, and a user interface component 308. The management platform 302 is configured to receive patient information from the information sources 304, 306, and 308 (any one or more of which may be examples of the information source 106 depicted in FIG. 1).

In embodiments, the PRM database 304 may include any number of different types of information associated with a patient (generally information that is at least partially different than the clinical information available from the EHR database 306). For example, the PRM database 304 may include at least one of psychosocial information, experiential information, relational information, preferential information, demographic information, barrier information, and compliance information. In embodiments, the PRM database 304 includes, incorporates, or is coupled to modules that enable the gathering of PRM information. These information gathering modules may include, for example, software programs, data entry forms, and/or the like. According to embodiments, a remote patient monitoring module may be used to gather information such as, for example, by providing an interactive experience on a mobile device, obtaining information from a medical device, and/or the like.

An example of a data gathering module includes a barrier assessment module. A barrier assessment module may be used to gather information associated with barriers to treatment, improvement, recovery, etc. that a particular patient faces. That is, for example, a barrier assessment may be designed to identify challenges that exist for patients and their caregivers that make it difficult for the patient to maintain good health and/or that otherwise contribute to a patient's risk score. Barriers may include behavior (e.g., an unwillingness to see doctors, etc.); mental state (e.g., depression, a lack of trust for caregivers, etc.); family issues (e.g., divorce, responsibilities associated with caring for an ill family member, etc.); medication/procedure side-effects; financial situation (e.g., uninsured, underinsured, inability to pay for care services, etc.); education (e.g., lack of general education, lack of specific education related to the patient's health, etc.); language; culture (e.g., religious beliefs, cultural norms, etc.); and/or the like. A barrier assessment module may include a questionnaire that elicits answers that are used to identify patient risk factors. A patient satisfaction module may be used, in embodiments, to gather patient satisfaction information which may be used to identify risk factors such as a patient's confidence in a care team, a patient's willingness to engage with a care team, or a patient's activation level. According to embodiments, a barrier assessment may be performed by a patient or by a healthcare provider with a patient, and may be administered, for example, via a website, in person, on paper, on a computer, on a mobile device, and/or the like.

The EHR database 306 may be provided by an EHR system, integrated with the management platform 302, and/or the like. The EHR database 306 may include any number of different types of clinical information associated with any number of different patients. The clinical information may be provided to the database 306 using any number of different types of electronic medical record (EMR) reporting architectures, PHR systems, direct entry, and/or the like.

The management platform 302 also is communicably coupled to one or more access devices such as, for example, a patient device 310, a caregiver device 312, and an insurer device 314 (any one or more of which may be examples of the access device 112 depicted in FIG. 1). The management platform 302 may also be communicably coupled to a service provider 316 (e.g., the service provider 110 depicted in FIG. 1). The management platform 302 may be configured to provide care pathway representations, care metrics, risk scores and/or other information to the access devices 310, 312, and 314 and the service provider 316, and/or to receive information from the access devices 310, 312, and 314 and the service provider 316. In embodiments, a service provider may be, include, or be included within, a component of the management platform 302 in lieu of, or in addition to, the illustrated service provider 316. In embodiments, for example, the communication component 334, described below, may be used as a service provider.

The management platform 302 includes a benchmark component 318, a risk analyzer 320, a tracking component 322, a care pathway manager 324 (e.g., the care pathway manager 108 depicted in FIG. 1), a care team component 326, and a patient referral component 328. In embodiments, the components 318-328 may be implemented in any combination of hardware, software, and/or firmware, and may be implemented, at least in part, by a controller, a processor, and/or the like (not shown). The management platform 302 may include any number of other components or combination of components including, for example, a security component, a user authorization component, a registration component, a software provisioning component, and/or the like.

The benchmark component 318 may be configured to determine, based on population patient information, benchmark information. The benchmark information may include, for example, information about baseline risk scores, baseline risk score factors, baseline influence levels, and/or the like, and may be dynamically modified using machine-learning techniques.

In embodiments, the risk analyzer 320 may utilize patient information received from the information sources 304 and 306, queries (and/or other user input) received from the user interface component 308, and/or information from other relevant sources, to analyze information related to a patient, and provide predictive assessments of the patient's well-being. These predictive assessments may include risk scores. In embodiments, for example, the risk score may include a score corresponding to at least one of a risk of admission (e.g., to a hospital or other clinical setting), a risk of readmission (e.g., to a hospital or other clinical setting), a risk of hospital utilization (which may, e.g., include outpatient and/or emergency services), a risk of high care cost (e.g., defined with reference to a threshold established by a user, a machine-learning algorithm, etc.), a risk of injury (e.g., a risk of falling), a risk of decompensation (e.g., a risk of mental, emotional, and/or physical health deterioration due to an existing illness or condition), a risk of noncompliance (e.g., a risk of noncompliance with a medication prescription, an exercise regimen, etc.), a risk of exacerbation of the patient's illness and/or condition, a risk of an adverse event (e.g., a risk of an undesirable health event or episode, a risk of an accident resulting from an undesirable health event or episode, etc.), and/or the like. The risk analyzer 108 also may identify one or more risk factors that contribute to the risk score, a level of contribution of each of the factors, and/or the like. Risk factors may include any number of different types of factors such as, for example, presence of an illness; stage of an illness; historical treatment outcomes; certain types of comorbidity (e.g., heart failure with comorbid COPD); age; sex; activity level; family history; address (e.g., location of residence); discharge day (e.g., day of the week, date, etc.); number of hospital admissions; rate of hospital admissions (e.g., number of hospital admissions with a specified time period); date of last hospital admission; diet; ward or unit of hospital in which the patient is placed or from which the patient has been discharged; family (e.g., whether the patient is married, has children, etc.); patient satisfaction with caregivers; level of patient education; language barriers; and/or the like. Illustrative embodiments of the risk analyzer 320 are described in U.S. Provisional Application No. 62/348,649, filed Jun. 10, 2016, and entitled “PATIENT RISK SCORING & EVALUATION SYSTEM,” the entirety of which is hereby expressly incorporated herein by reference for all purposes.

The tracking component 322 may be configured to track care metrics, care episodes, care episode information, risk score calculations, risk factor information, and/or the like. For example, the tracking component 322 may store each calculated care metric on a storage device 330 that may include a database 332. The tracking component 322 may associate a time stamp with each care metric calculation and care episode identification, and index these (along with, in embodiments, care pathway definitions and/or modifications) using the database 332. In this manner, a caregiver may be able to ascertain, (e.g., using a query) the time of the last update of a care metric and/or care pathway definition.

The database 332 may be, be similar to, include, or be included within the database 114 depicted in FIG. 1. For example, the database 332 may include a number of databases such as, for example, a patient database, a population database, a medical database, a general database, and/or the like. The database 332 may include patient specific data, including care pathway definitions, care episode codes, care episode information, care metrics, risk scores, risk factors, care team identifications, and/or the like. According to embodiments, the database 332 may include non-patient specific data, such as data relating to other patients and population trends. The database 332 may include epidemic-class device statistics, patient statistics, data relating to staffing by health care providers, environmental data, pharmaceuticals, and/or the like. Embodiments of the database 332 may include clinical data relating to the treatment of diseases, historical trend data for multiple patients in the form of a record of progression of their disease(s) along with markers of key events, and/or the like. The database 332 may include non-medical data related to the patient. In embodiments, the database 332 may include external medical records maintained by a third party, such as drug prescription records maintained by a pharmacy, providing information regarding the type of drugs that have been prescribed for a patient.

In embodiments, the care pathway manager 324 may be configured to manage care pathways, analyze patient information in the context of care pathways (e.g., to assess care pathway compliance), identify care episodes, extract care episode information from patient information, index information using the database 332, and/or the like. The care pathway manager 324 may, for example, generate a care pathway definition based on user input, system parameters, patient information, and/or other types of information (e.g., standardized care guidelines, results of analyses of empirical information, etc.). According to embodiments, a user (e.g., a clinician or other care provider) may interact with the care pathway manager 324 to develop a care pathway definition. A care pathway definition may include a care pathway structure and any number of care pathway steps organized according to that structure. To facilitate creation of care pathway definitions, the care pathway manager 324 may, in embodiments, cause a display device associated with an access device (e.g., a patient device 310, caregiver device 312, insurer device 314) to present a user interface that includes functionality configured to facilitate creation of a care pathway definition. For example, the user interface may include any number of different types of tools, interactive illustrations, and/or the like.

The care pathway manager 324 may also be configured to determine one or more care metrics based on patient information and one or more care pathway definitions, as described above with respect to the care pathway manager 108 depicted in FIG. 1. In embodiments, the care pathway manager 324 analyzes the information received from the various information sources. For example, the care pathway manager 324 may be configured to analyze historical symptoms, diagnoses, and outcomes along with time development of the diseases and co-morbidities. The care team component 326 may be configured to identify, based on the care pathway definition, a care team appropriate for implementing the care pathway. In embodiments, for example, the care team component 326 may be configured to reference an indexed list of care providers to identify, based on a particular care pathway step, a care provider appropriate for implementing that particular care pathway step. In embodiments, to facilitate this identification, each of a number of care providers may be associated with one or more stage and step ID codes. The patient referral component 328 may be configured to facilitate putting the patient into contact with a care provider, schedule an appointment with a care provider, prioritize delivery of care services (e.g., based on care pathway definitions), and/or the like.

One or more of the components 318-328 depicted in FIG. 3 may be configured to use various algorithms and mathematical modeling such as, for example, trend and statistical analysis, data mining, pattern recognition, cluster analysis, neural networks and fuzzy logic. For example, the care pathway manager 324 may perform deterministic and probabilistic calculations. Deterministic calculations include algorithms for which a clear correlation is known between the data analyzed and a given outcome. In embodiments, the benchmark component 318, the risk analyzer 320, the tracking component 322, the care pathway manager 324, the care team component 326, and/or the patient referral component 328 may include machine-learning capabilities. For example, the one or more of the components 318-328 may be implemented via a neural network (or equivalent) system. One or more of the components 318-328 may be partially trained (i.e., the care pathway manager 324 may be implemented with a given set of preset values and then learn as the advanced patient management system functions) or untrained (i.e., the care pathway manager 324 may be initiated with no preset values and must learn from scratch as the advanced patient management system functions). In embodiments, one or more of the components 318-328 may continue to learn and adjust as the advanced patient management system functions (i.e., in real time), or may remain at a given level of learning and only advanced to a higher level of understanding when manually allowed to do so.

In addition, patient-specific clinical information may be stored and tracked for hundreds of thousands of individual patients, enabling a first-level electronic clinical analysis of the patient's clinical status and an intelligent estimate of the patient's short-term clinical prognosis. The management platform 302 may be capable of tracking and forecasting a patient's risk with increasing levels of sophistication by measuring a number of interacting co-morbidities, all of which may serve individually or collectively to degrade the patient's health. This may enable the management platform 302, as well as caregivers, to formulate a predictive medical response to oncoming acute events in the treatment of patients with chronic diseases such as heart failure, diabetes, pain, cancer, and asthma/COPD, as well as possibly head-off acute catastrophic conditions such as MI and stroke.

In embodiments, the management platform 302 includes a communication component 334 that may be configured to coordinate delivery of feedback based on analysis performed by the care pathway manager 324. For example, in response to the care pathway manager 324, the communication component 334 may manage medical devices, perform diagnostic data recovery, program the devices, and/or otherwise deliver information as needed. In embodiments, the communication component 334 can manage a web interface that can be accessed by patients and/or caregivers. The information gathered by an implanted device may be periodically transmitted to a web site that is securely accessible to the caregiver and/or patient in a timely manner (e.g., via a caregiver portal). In embodiments, a patient accesses detailed health information with diagnostic recommendations based upon analysis algorithms derived from leading health care institutions.

The illustrative health management system 300 shown in FIG. 3 is not intended to suggest any limitation as to the scope of use or functionality of embodiments of the present disclosure. Neither should the illustrative health management system 300 be interpreted as having any dependency or requirement related to any single component or combination of components illustrated therein. Additionally, various components depicted in FIG. 3 may be, in embodiments, integrated with various ones of the other components depicted therein (and/or components not illustrated), all of which are considered to be within the ambit of the present disclosure. For example, any one or more of the components 318-334 may be integrated with any one or more of the other components 318-334.

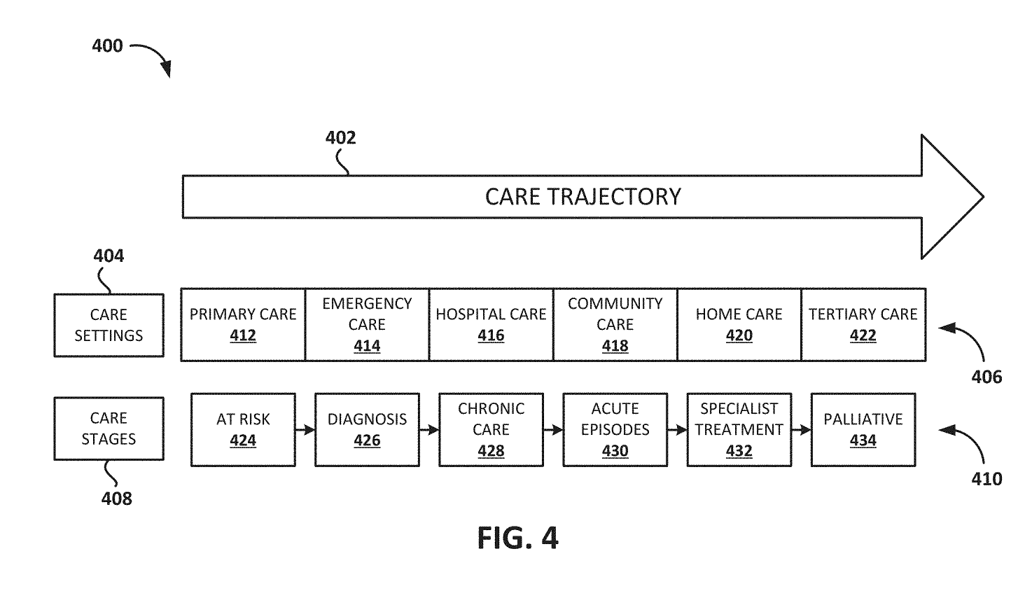

In embodiments, a care pathway manager (e.g., the care pathway manager 108 depicted in FIG. 1 and/or the care pathway manager 324 depicted in FIG. 3) may be configured to cause the display device to present a configurable representation of a care pathway structure. FIG. 4 depicts an illustrative representation 400 of a care pathway structure that may be presented via a display device. As shown, the representation 400 of the care pathway structure includes a care trajectory indicator 402 that indicates a chronological direction representative of a patient's care journey. The representation 400 also includes a “CARE SETTINGS” header 404 associated with a set 406 of care setting identifiers, each of which indicates a particular type of care setting. The illustrated care pathway structure representation 400 also includes a “CARE STAGES” header 408 associated with a set 410 of care stage identifiers, each of which indicates a particular care stage.

As shown, each care stage identifier may correspond to a care setting identifier by being aligned below the corresponding care setting identifier. In the illustrated care pathway structure representation 400, the set 406 of care settings identifiers includes a “PRIMARY CARE” identifier 412, an “EMERGENCY CARE” identifier 414, a “HOSPITAL CARE” identifier 416, a “COMMUNITY CARE” identifier 418, a “HOME CARE” identifier 420, and a “TERTIARY CARE” identifier 422. The illustrated set 410 of care stage identifiers includes an “AT RISK” identifier 424 corresponding to the “PRIMARY CARE” identifier 412, a “DIAGNOSIS” identifier 426 corresponding to the “EMERGENCY CARE” identifier 414, a “CHRONIC CARE” identifier 428 corresponding to the “HOSPITAL CARE” identifier 416, an “ACUTE EPISODES” identifier 430 corresponding to the “COMMUNITY CARE” identifier 418, a “SPECIALIST TREATMENT” identifier 432 corresponding to the “HOME CARE” identifier 420, and a “PALLIATIVE” identifier 434 corresponding to the “TERTIARY CARE” identifier 422. Any number of different types of care setting identifiers and/or care stage identifiers may be included in accordance with various embodiments.

The care pathway structure representation 400 depicted in FIG. 4 describes a high level care pathway. This high level care pathway could apply to any disease or condition, and may be particularly suited for use with chronic conditions. Care pathways may also be described as clinical management pathways, critical pathways, care maps, integrated care pathways, chains of care, and/or the like. A complete care pathway may incorporate multiple care settings, multiple care providers (e.g., hospital staff, general practitioners, specialists, public health nurses, homecare nurses, spouses, therapists, etc.), multiple care stages, and multiple care pathway steps. A care pathway may overlap, reference, or be otherwise associated with any number of other care pathways and may continue for any duration. That is, for example, a care pathway may be used for the course of a temporary disease or condition, or, in the case of a permanent chronic condition, may continue for the lifetime of the patient.

In various examples, illustrative stages in the journey of a patient having a chronic condition can be described in summary as follows. At a first illustrative care pathway stage (e.g., an “ONSET” stage or an “AT-RISK” stage), a patient may have a disease or condition but the fact that the patient has that disease or condition may not be obvious as it may not be causing any signs or symptoms. In other examples of the first care pathway stage, a patient may be recognized as someone that is at risk of a certain disease or condition e.g. an obese person is at risk of heart failure, or the patient may have an illness that is causing signs and symptoms. At a second illustrative care pathway stage (e.g., a “DIAGNOSIS” stage), when the patient presents with signs or symptoms, they may be assessed in an effort to determine the underlying cause. This assessment may involve different tests. Following diagnosis, at a third illustrative care pathway stage (e.g., a “CHRONIC CARE” stage), the condition may be managed using medication, lifestyle changes, and/or other means. The third care pathway stage may also include further assessment to understand the etiology of the patient's condition or to understand the severity of their condition to help the provider to decide upon the best course of action to treat the patient. In embodiments, this further (and, in some cases, ongoing) assessment may be categorized in a separate stage from the third care pathway stage.

As the disease or condition in this example progresses, hospital use may become more common, for example, as a result of acute events such as exacerbations (e.g., in the case of COPD) or decompensation (e.g., in the case of heart failure). Often patients are readmitted many times to hospital during this illustrative fourth care pathway stage (e.g., an “ACUTE EPISODES” stage). Eventually, the patient may receive specialized treatment in a fifth illustrative care pathway stage (e.g., a “SPECIALIST TREATMENT” stage), e.g., if they become refractory to medication. Surgery may be performed, medical devices may be implanted, or the like. For example, a patient may have heart valve surgery, or, in the case of AF, the patient may undergo a pulmonary vein isolation or left atrial appendage occlusion procedure. Nearer the end of life for a patient, palliative care may be administered in a sixth illustrative care pathway stage (e.g., a “PALLIATIVE” stage). According to embodiments, a care pathway may include any number of different stages. In embodiments, any number of different naming conventions may be used to describe the steps, categories and/or processes associated with care pathways.

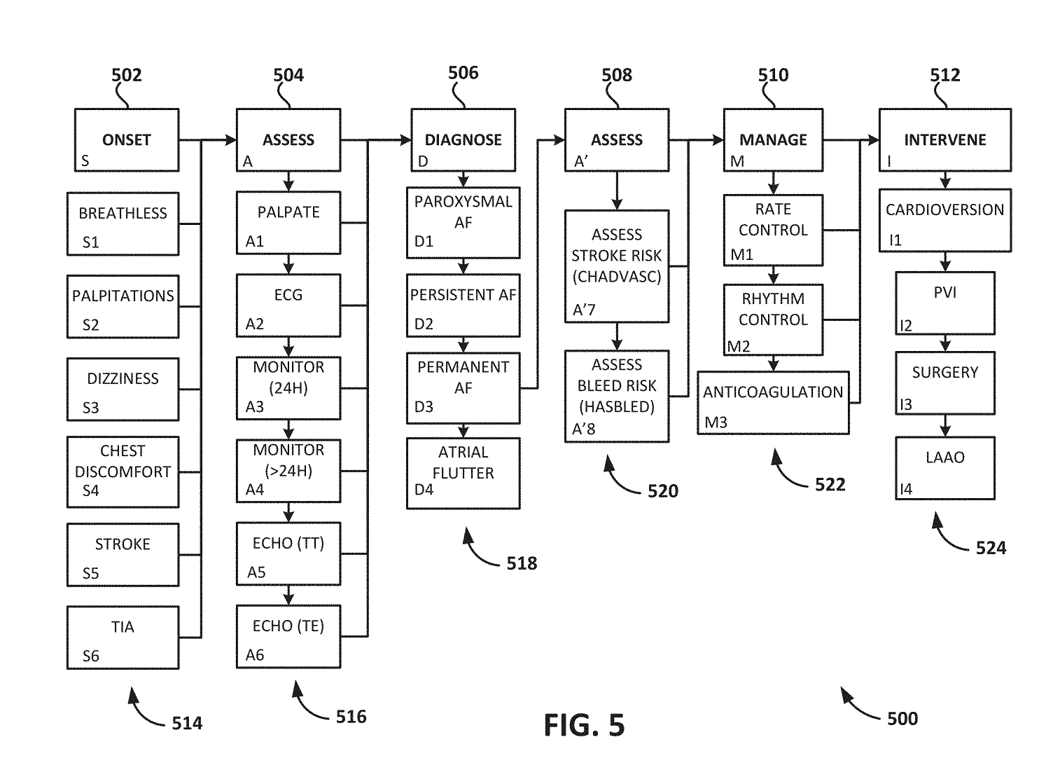

FIG. 5 is a block schematic diagram of a representation 500 of an illustrative care pathway definition associated with a patient that has atrial fibrillation (AF), in accordance with embodiments of the disclosure. A care pathway definition may include a care pathway structure characterized by an ordered number of care pathway stages, and any number of care pathway steps may be associated with each care pathway stage. The AF care pathway definition depicted by the representation 500 is presented to illustrate concepts of embodiments of the disclosure, and is not intended to suggest any limitations on care pathways generally, or AF care pathways in particular.

According to various embodiments, a care pathway definition may be, be similar to, be derived from, include, or be included within, a pathway created by best-practice and/or guideline publishing organizations such as, for example, National Institute for Health and Care Excellence (NICE) in the UK; the Centers for Disease Control (CDC) in the U.S., and/or the like. Care pathway definitions developed by these organizations may be described as general pathways. In many cases, care providers may not be using a general care pathway exactly, but may instead, use a localized version that is specific to their particular organization, to their healthcare network, to their region, and/or the like. In embodiments, general care pathway definitions may be pre-loaded into the system for users to access and utilize, and the system also may provide the option for the user to input or provide a local care pathway definition or to edit a pre-loaded general pathway to create a local pathway within the system.

As shown in FIG. 5, the illustrative representation 500 of the AF care pathway definition may include a care pathway structure having a number of ordered care pathway stages: “ONSET” 502, “ASSESS” 504, “DIAGNOSE” 506, “ASSESS” 508, “MANAGE” 510, and “INTERVENE” 512. These care pathway stages represent categories of care and, in embodiments, are used for care episode coding. In embodiments, a user provides a care pathway definition to a care pathway manager (e.g., the care pathway manager 108 depicted in FIG. 1 or the care pathway manager 324 depicted in FIG. 3), and this definition is provided, via user input that includes indications of care pathway identification stage (ID) codes, care pathway step ID codes, and care pathway episode ID codes.

For each ID code, the user may also provide a weighting, which can be associated with the code to indicate a relative importance, priority, and/or urgency associated with the corresponding care pathway stage/step. The weighting can be based on any number of different types of factors such as, for example, a materiality of a particular care pathway step (e.g., the current step and/or a subsequent step) to the overall prognosis of the patient; a severity of a particular symptom, illness, or condition; availability of resources (e.g., medicine, expertise, etc.); and/or the like. In embodiments, for example, a weighting may be used, by an aspect of the system (e.g., a client application implemented on a clinician's mobile device), to facilitate prioritization of interventions and/or other clinical actions to be taken. That is, for example, in embodiments, a weighting associated with a first care pathway step may be greater than a weighting associated with a second care pathway step, in which case, a decision may be made (e.g., by a processor and/or a clinician) to perform the first care pathway step before performing the second care pathway step. In embodiments, a care pathway step may include a number of associated weightings, which may be used in any number of manners. For example, certain weightings associated with a care pathway step may be used in association with certain decisions, while others are used in association with other decisions. In embodiments, a care pathway step may be implemented in response to determining that a combination (e.g., a sum, a product, an average, etc.) of a number of weightings associated with that care pathway step exceeds a threshold and/or falls within a certain range. Any number of other calculations and/or considerations may be incorporated into decisions such as those described above. In embodiments, for example, a patient may report two different symptoms and each one may have an associated weighting. A method may include calculating an overall weighting score by adding together the individual weightings. If the combined score exceeds a threshold and/or another weighting, this might drive a particular recommendation.

Any number of care pathway steps may be associated with a care pathway stage and may be represented, as shown in FIG. 5, by aligning the steps beneath the associated stages. That is, for example, the “ONSET” stage 502 includes a first set 514 of care pathway steps, the “ASSESS” stage 504 includes a second set 516 of care pathway steps, the “DIAGNOSE” stage 506 includes a third set 518 of care pathway steps, the “ASSESS” stage 508 includes a fourth set 520 of care pathway steps, the “MANAGE” stage 510 includes a fifth set 522 of care pathway steps, and the “INTERVENE” stage 512 includes a sixth set 524 of care pathway steps. Each care pathway step is assigned a care pathway step ID code, which also may be provided via user input. The care pathway definition includes the care pathway structure, stage/step ID codes, and weightings.

In embodiments, one or more keywords may be associated with each care pathway step/stage ID code. In embodiments, the one or more keywords may include a single search word or description, or multiple search words or descriptions. A care pathway manager may be configured to search patient information for care episodes containing the search words or descriptions, and may be configured to index any such identified care episodes using the corresponding ID code. The care pathway manager also may be configured to extract, from the patient information, episode information associated with an identified care episode. Aspects of the episode information may also be indexed using the corresponding ID code.

Table 1, below, describes illustrative care pathway coding that may be used according to various embodiments.

TABLE 1

| Care Pathway Stage/ | Care Pathway Step | |
|---|---|---|
| Step ID Code | Category | Description |
| S or O | Symptoms or Onset | At this stage, due to patient reported symptoms and |
| | | signs, the patient is suspected of having a certain |
| | | disease or condition. A patient may have no signs or |
| | | symptoms but still may be discovered to have a disease |
| | | or condition after testing. A patient with comorbidities |
| | | may be tested because it is felt that they are at risk of |
| | | having another disease or condition. A patient may be |
| | | discovered to have a disease or condition more by |
| | | chance if they are undergoing a routine health check or |
| | | screening. |
| A | Assessment | At risk patients or suspected patients may immediately |
| | | undergo tests or may be referred to another care |
| | | provider or another site of care for a diagnostic test. |
| D | Diagnosis | As a result of testing a patient may get diagnosed with a |
| | | disease or condition. A physician my use their clinical |
| | | judgement to diagnose a patient based on signs and |
| | | symptoms and this diagnosis may be recorded in the |
| | | patient record. |
| M | Management | A patient may be prescribed medication and |
| | | recommended lifestyle changes to manage their |
| | | condition and in particular to manage symptoms. |
| I | Interventions | Patients in the later stages of their condition or disease |
| | | may receive a further intervention especially when they |
| | | may become refractory to treatment by medication. The |
| | | interventions may be surgical, invasive or minimally |
| | | invasive. The intervention may involve a medical device |
| | | which could be implanted in the patient e.g. a stent or |
| | | pacemaker. |
| P | Palliative | When a patient enter the last stage or their disease or |
| | | condition the care they receive is focused on managing |
| | | symptoms such as pain to make a patient comfortable as |
| | | they approach end of life. |

According to embodiments, the user may complete a “definition” task for each care pathway step. For example, within the ONSET stage, the user may define a number of care pathway steps. One such care pathway step may be “Breathlessness” (in the case of AF). The user or system may create a care pathway step ID code for this step e.g. “O1,” and the user may assign a weighting to this step. If the step is of high importance compared to other steps within the care pathway stage, then the step may receive a higher weighting or rating then other steps in the same care pathway stage. In this manner, for example, if the weighting of an ONSET step is higher than the weighting of another ONSET step, this may drive a more urgent response for the step that has the higher weighting. An urgent response might be, for example, the immediate ordering of a particular test for a patient.

As indicated above, a care pathway manager may utilize one or more keywords as search words or terms that allow the care pathway manager to identify care episodes that relate to a particular care pathway step. Using the one or more keywords, the care pathway manager may search, find, and extract care episode information (e.g., specific healthcare information that is pertinent to the care pathway step). According to embodiments, the care pathway manager may be configured to structure the episode information chronologically to align with a pre-defined care pathway framework.

If, for example, a patient presents to a general practitioner with breathlessness, an S1 code may be associated with that care episode. If, during that care episode, the patient underwent an ECHO test, the episode may be recoded because an ECHO test occurs later in the pathway, and the care pathway manager may be configured to recognize that the patient has progressed beyond the “Onset” or “Symptom” stage of the pathway. Table 2 contains some illustrative keywords that may, in embodiments, be used to find and identify care episodes as “O” or “S” episodes, in the case of an AF care pathway.

TABLE 2

| Code | Key words/search words |
|---|---|
| S1 | Breathlessness |
| S2 | Palpitations |
| S3 | Dizziness |
| S4 | Chest discomfort |
| S5 | Stroke |
| S6 | Transient Ischemic Attack (TIA) |

The examples in Table 2 include signs and/or symptoms. Similarly, causes and/or risk factors of AF such as, for example, obesity and hypertension may be used as keywords. In this manner, the system may be configured to identify when a patient appears with AF risk factors and may be configured to determine care metrics such as, for example, how often patients with risk factors were assessed for possible AF or underwent an annual check-up to enable early diagnosis of AF.

Table 3, below, contains example care pathway step ID codes and weightings for the AF care pathway definition depicted in FIG. 5.

TABLE 3

| | | | DESCRIPTION/ | |
|---|---|---|---|---|
| | PATHWAY | PATHWAY | SEARCH WORD | WEIGHT- |
| CODE | STEP | SUBSTEP | OR TERMS | ING |
| S1 | ONSET | 1 | Breathlessness | 10 |
| | | | Difficulty breathing | |
| S6 | ONSET | 6 | TIA | 30 |
| A2 | ASSESS | 2 | ECG | 10 |
| A5 | ASSESS | 5 | ECHO | 10 |

In embodiments, the weighting, which may be referred to as a priority weighting (PW) (though it may be related to priority, severity, and/or the like) may be intended to assign a priority or importance level to a pathway step. As an example, within the ONSET pathway stage, a patient can have an episode of care where they present with breathlessness, or they may have an episode of care where it was determined that they experienced a transient ischemic attack (TIA). In response to either episode, further assessment should be conducted to determine the root cause. However, because TIA was assigned a higher PW, the care pathway manager may decide that a more urgent action should be taken when a TIA occurs than that taken when a patient presents with breathlessness.

According to various embodiments, the order in which care pathway steps should be completed may be defined by the care pathway step ID code and/or by the PW. In embodiments, the order of completion of care pathway steps may not be important. For example, in the case of the ONSET stage, the care episodes are often identified as patients are presenting with signs or symptoms. The order in which the signs and symptoms are reported may not be important. In some cases, the order of steps may not be important when conducting analytics for a population of patients but they may be important when conducting analytics and using the system for an individual patient. However, the PW may cause an otherwise arbitrarily ordered care pathway step to be more important. For example, if a patient presents with breathing difficulty on day one, a provider may not feel the need to conduct follow-up urgently, but if the patient presents with chest pain (higher PW) on day one, then this may be dealt with more urgently.

In another example, a specific test conducted as part of a patient assessment may be assigned a lower priority rating than another test because research may show that it is not effective at diagnosing a condition with accuracy. For example, pulse palpation is recommended for a patient suspected of having AF, but the test has a relatively low specificity for atrial fibrillation, even though its sensitivity is relatively high. Therefore, it may be assigned a weighting that is in line with the specificity of the test. Similarly, in another example, if treatment with a certain drug is proven to be more effective than treatment with another drug, a higher priority rating may be associated with the treatment having the higher efficacy. In this manner, during operation, the care pathway manager may be used to identify such “high priority” or “high PW” events and may be configured to provide alerts, guidance and/or recommendations to health care providers, e.g., to move a patient to the next recommended care pathway step when they occur. The care pathway manager may also be configured to perform retrospective analysis to identify how well providers were responding to “high PW” care episodes. For example, the care pathway manager may generate a report detailing how long it took to respond or how long it took for the next step in the pathway to be conducted. For groups of patients, the care pathway manager may determine response performance at a population level or for different care providers.

In addition to identification and coding of episodes of care for indexing in association with a care pathway definition, episode information associated with each episode may be extracted and may be, in embodiments, stored in a Care Episode Record. Such information may include, for example, the date and time when the episode occurred, the care pathway step ID code assigned to the episode, the weighting associated with that code, an indication that the episode is linked with one or more other care episodes, and/or the like. The Care Episode Record may be indexed using the corresponding care pathway step ID code.

In embodiments, the care pathway manager also may be configured to identify links between care episodes. Similarly, the care pathway manager may be configured to identify care episodes that are independent (e.g., not linked to another care episode). For example, a patient may present with symptoms of AF at a hospital and, during this episode of care, a specialist may order for the patient to have an ECG test completed at a later date. The patient may return at a later date for the ECG test. Both of these episodes may be considered to be linked since one episode occurred as a consequence (or is otherwise related to) the other episode. On the other hand, a patient may present with symptoms of AF to a first doctor and the doctor may decide not to send the patient for further evaluations. At a later date, the patient may receive an ECG test; perhaps as a result of a visit to a second doctor. The episode involving the first doctor and the ECG test may not be linked. Instead, these two episodes may be identified as independent.

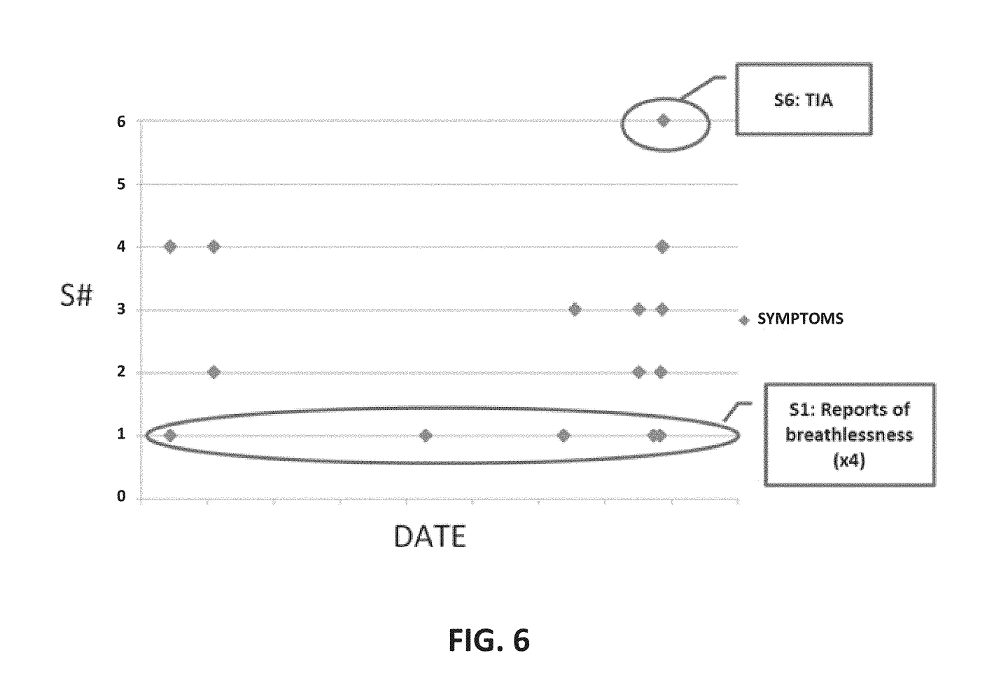

Using the a care pathway definition created in accordance with embodiments of the procedures described above, the care pathway manager may be configured to determine one or more care metrics and cause the metrics and/or other information to be provided to one or more users, e.g., via a dashboard. FIG. 6 depicts an illustrative graph that may be presented on a dashboard in accordance with embodiments of the disclosure. The graph depicted in FIG. 6 (or a similar graph) may be created by first identifying reports for symptoms reported in patient records that match with symptoms defined in the care pathway or pathways under investigation. In the illustrated example, a care pathway for AF is considered. The symptoms defined for the illustrative AF care pathway and the codes for each symptom are listed in Table 2, above. On the timeline plot in FIG. 6, a diamond-shaped marker indicates a point in time when an AF symptom was reported and recorded in a patient record. For example, all markers sitting along line S#1 represent a report of patient breathlessness. In embodiments, by scrolling over each time point and/or diamond (e.g., using mouse and cursor or using finger or stylet on a tablet) the user may be presented with a summary report of the patient info for that episode. According to embodiments, any number of different types of graphical representations of care pathway-related information.

According to embodiments, dashboard presentations may facilitate triaging care response. That is, for example, the care pathway manager may be configured to rank individual patients using weighting. For example, if a patient has one symptom with a PW of 5 and another has a more severe PW with a ranking of 10, then the patient with the higher PW can be prioritized for moving to the next care pathway step. This may facilitate helping providers to treat higher risk patients first. In this manner, during periods when the provider is extremely busy, the provider can concentrate on treating the high PW patients and, during periods when the provider is less busy, the provider can treat the lower PW patients. In this way, embodiments of the disclosure may facilitate balancing workloads and response times.

In embodiments, some care episodes may be considered to be trigger events. The care pathway manager may be configured to identify trigger events by using the associated PW. In this manner, the care pathway manager may be configured to analyze pathway variance by starting at a trigger event and analyzing all episodes after or before that trigger event to gain insight into how patients were treated. One such trigger event might be, for example, an episode when a diagnosis was made or an episode when a patient entered a hospital.

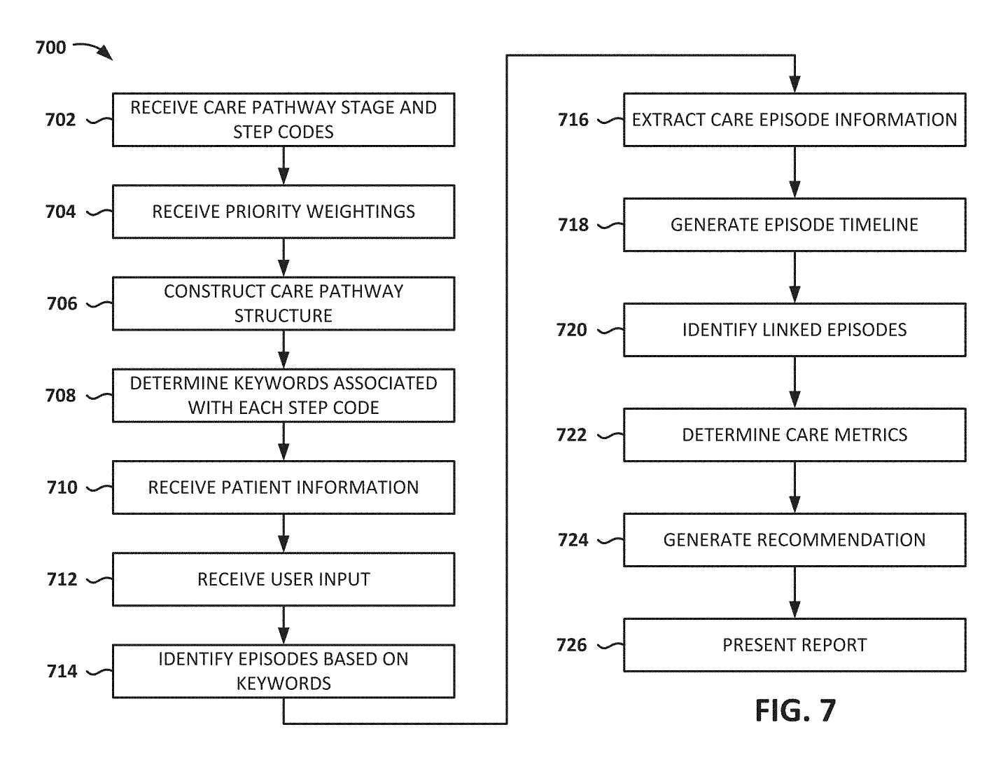

According to embodiments, systems discussed herein may facilitate health management of a patient. FIG. 7 is a flow diagram depicting an illustrative method 700 of facilitating management of a care pathway, in accordance with embodiments of the disclosure. Aspects of embodiments of the illustrative method 700 may be performed by any number of different components discussed above with regard to FIGS. 1-3. As shown in FIG. 7, embodiments of the method 700 include receiving care pathway stage and step codes (block 702). For example, embodiments of the method 700 may include receiving a first stage identification (ID) code and a second stage ID code, the first stage ID code corresponding to a first care pathway stage and the second stage ID code corresponding to a second care pathway stage. The method 700 also may include receiving a first step ID code and a second step ID code, the first step ID code corresponding to a first care pathway step and the second step ID code corresponding to a second care pathway step. As depicted in FIG. 5 above, the stage and/or step ID codes may include combinations of letters and/or numbers that provide an indication of the location of the associated stage or step within the care pathway definition. In embodiments, any number of different types of conventions may be used for establishing ID codes.

Embodiments of the method 700 further include receiving weightings (block 704). In embodiments, for example, the method 700 may include receiving user input comprising an indication of a first weighting and an indication of a second weighting; and associating, based on the user input, the first weighting with a first care pathway step; and associating, based on the user input, the second weighting with a second care pathway step. In embodiments, generating a care recommendation may include determining that the first weighting is greater than the second weighting.

The method 700 may also include constructing a care pathway structure (block 706). In embodiments, the care pathway structure may be created by establishing a care pathway trajectory defining an intended chronological order associated with the first and second care pathway stages; associating the first care pathway step with the first care pathway stage; and associating the second care pathway step with the second care pathway stage.

According to embodiments, the method 700 includes determining keywords associated with each step ID code (block 708). The keywords may be determined by extracting them from user input, by accessing a database in which the keywords are indexed, by applying a classifier or other machine-learning technique, and/or the like. Embodiments of the method 700 also include receiving patient information (block 710). The patient information may include clinical information and at least one of psychosocial information, experiential information, relational information, preferential information, demographic information, barrier information, and compliance information.

Embodiments of the method 700 further include receiving user input (block 712). The user input may include, for example, a user query, patient feedback, and/or the like. The method 700 also may include identifying episodes, based on the patient information, one or more keywords, and/or the user input (block 714). For example, a care episode may be identified by searching at least a portion of the patient information for a keyword associated with a particular care pathway step. The keyword search may also include searching for words similar to the keyword (e.g., misspellings of the keyword, words having the same or similar meaning as the keyword (and/or misspellings of those words), words commonly associated with the keyword, etc.). Any number of different types of searching strategies and techniques may be used in accordance with embodiments of the disclosure.

The method 700 also may include extracting care episode information (block 716), and generating an episode timeline (block 718). Embodiments of the method 700 also include identifying linked episodes (block 720), and determining one or more care metrics (block 722). Embodiments of the method 700 also include generating a recommendation (block 724); and presenting a report (block 726). In embodiments, the step of presenting a report may include presenting a representation of a care metric, which may be performed by causing a display device to present the representation. The representation of the care metric may include, for example, a number, a graph, a graphical representation, an image, and/or the like.

According to embodiments, outputs from the analysis may be presented in the form of decision trees on dashboards created by the care pathway manager. Additionally, in embodiments, patient information may include gaps where data was not provided or where the data is inaccurate. In this case, embodiments of the care pathway manager may facilitate generating gap-filler information. The gap-filler information may be generated using machine-learning algorithms, interpolation, extrapolation, user input, and/or the like.

According to various embodiments, the care pathway definition generated in illustrative steps 702-706 may be stored and reused as often as desired. For example, in embodiments, a care pathway manager may be configured to receive (e.g., receive as input, retrieve from memory, and/or otherwise access) a care pathway definition as part of an illustrative method that includes one or more of the steps 708-726 depicted in FIG. 7. In this manner, care pathway definitions may be managed throughout a care system, shared between different devices, accessed by different users, and/or the like, thereby facilitating continuity of care.

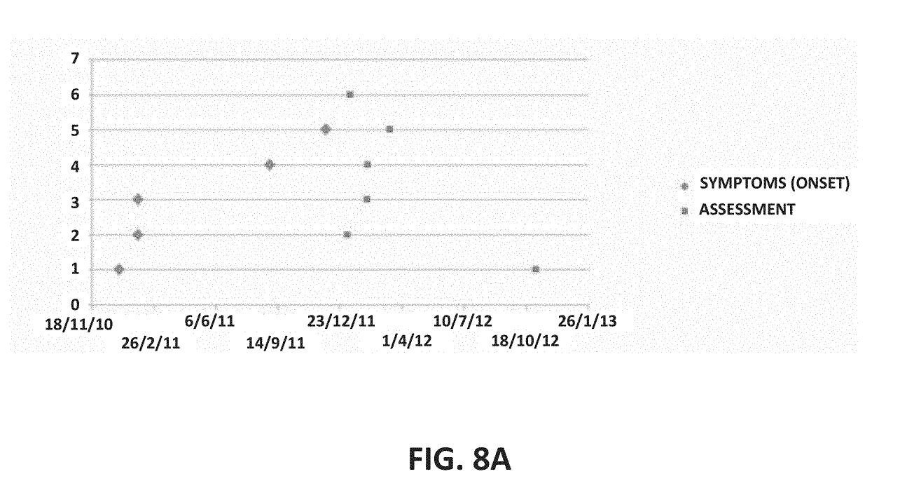

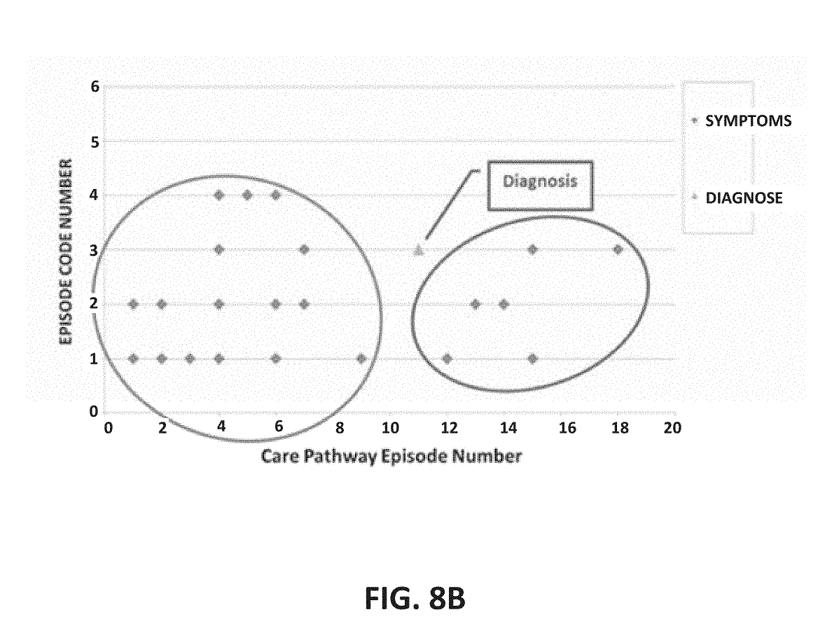

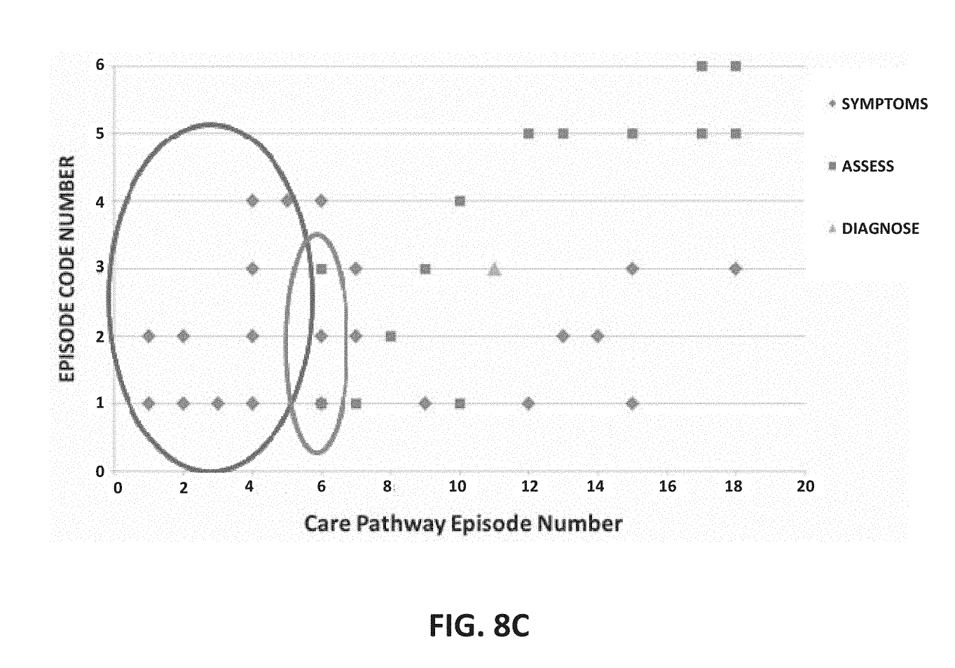

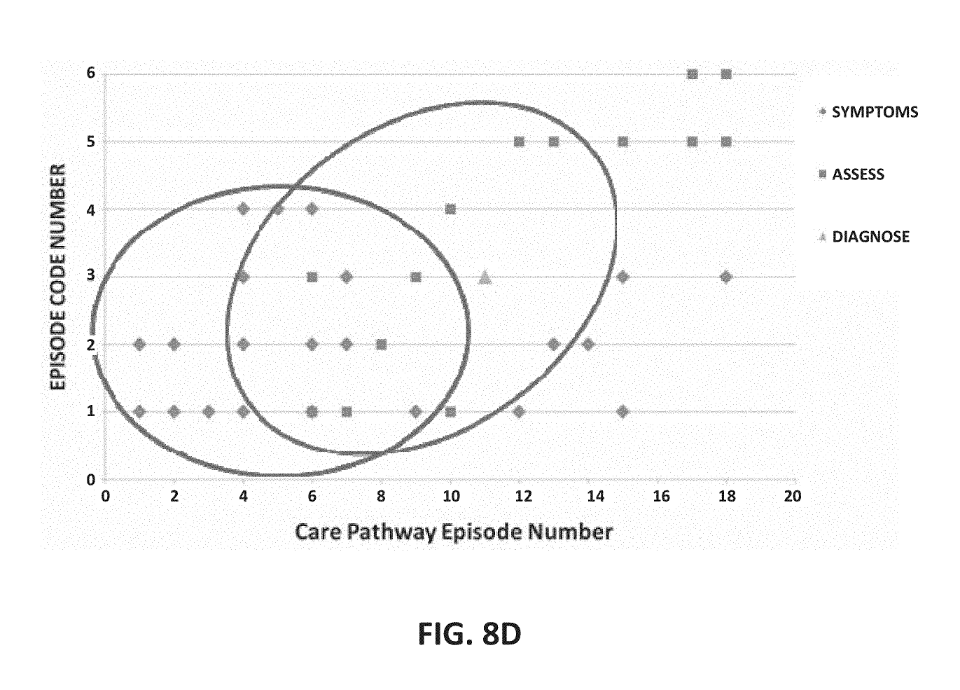

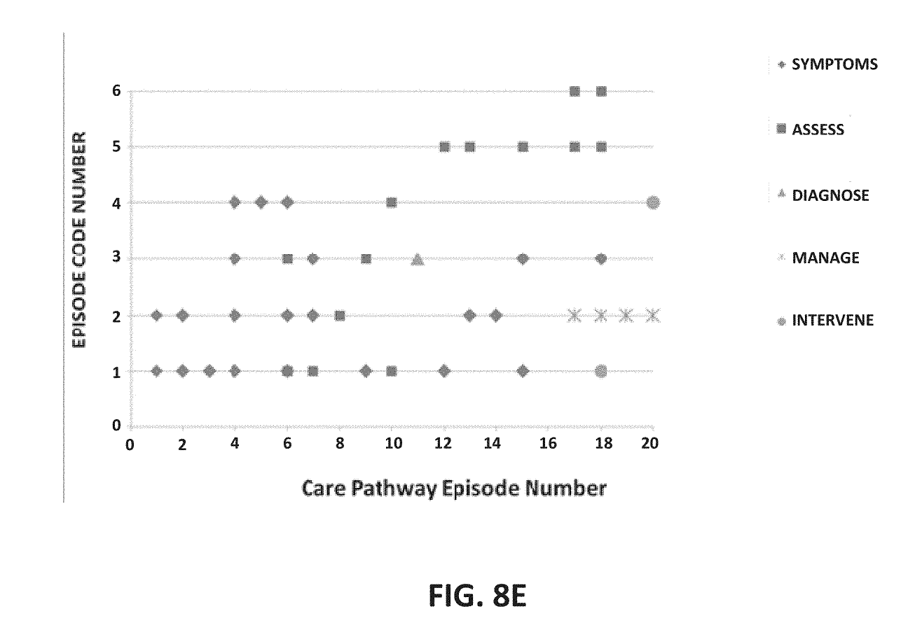

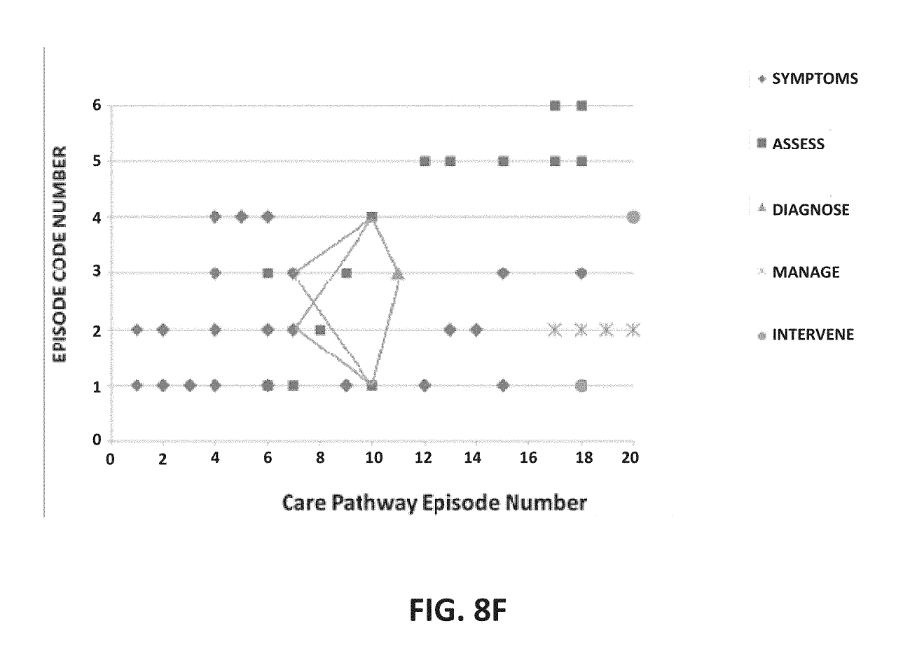

FIG. 8A depicts an illustrative graph that may be presented on a dashboard in accordance with embodiments of the disclosure. In FIG. 8A, “symptom” episodes are overlaid on “assessment” episodes, and presented on a timeline so that the user can see when the episodes took place and where there is overlap. FIG. 8B depicts another illustrative graph may be presented on a dashboard in accordance with embodiments of the disclosure. The graph depicted in FIG. 8B includes an illustrative graphical summary of a sub-set of care episodes for a single patient. The vertical axis corresponds to episode code numbers, and the horizontal axis corresponds to the occurrences of events (e.g., episodes, diagnoses, etc.), in which the “Care Pathway Episode Number” refers to the sequential occurrence of care pathway episodes. In embodiments, the horizontal axis may correspond to time and/or date. Care episodes where symptoms of AF were reported are represented by diamonds. A single care episode when a diagnosis of AF was assigned to the patient is represented by the triangle. In embodiments, this care episode might result, for example, in assignment of an ICD (International Classification of Diseases) code for AF to the patient.

In FIG. 8B, the care pathway episodes within the circle on the left occurred before a patient was diagnosed with a condition or disease. The episodes within the circle on the right occurred after diagnosis. All episodes represented by a diamond included reports of AF symptoms (e.g., palpitations or chest pain). Treatment occurring after diagnosis should reduce the number of reports of symptoms if effective. Treatment should manage symptoms and thereby improve quality of life. Thus, in embodiments, the graph illustrated in FIG. 8B may be used to facilitate the improvement of care by setting, as a goal, a reduction of the number of diamonds within the circle on the right, and monitoring updates to the graph.

In the illustrated graph, the horizontal axis corresponds to the care episode number. In other embodiments, the horizontal axis may correspond to the date on the calendar when the care episodes took place. Compliance or adherence by providers to a care pathway may result in reduction of the number of reports of symptoms pre-diagnosis. An excessive number of symptom reports prior to “assessment” episodes or diagnosis may indicate that patient are not being “pushed” to the next step of the care pathway in a timely manner. In embodiments of the system, this might alert a provider to seek the root cause of why patients are not progressing to the next step in the pathway as recommended.

FIGS. 8C and 8D depict illustrative graphs that may be presented on a dashboard in accordance with embodiments of the disclosure. The illustrative graphs depicted in FIGS. 8C and 8D present episodes of care coded as “symptoms” or “onset” or “symptomatic” alongside the episodes that are coded as “assessment”. The vertical axis corresponds to episode code numbers, and the horizontal axis corresponds to the occurrences of events (e.g., episodes, diagnoses, etc.), in which the “Care Pathway Episode Number” refers to the sequential occurrence of care pathway episodes. In embodiments, the horizontal axis may correspond to time and/or date. The symptom episodes are indicated by diamonds, while the assessment episodes are indicated by squares. The episodes contained in the leftmost circle are episodes where symptoms were reported before any assessment episode occurred. This is a measure of the delay in conducting an assessment despite reports of symptoms. In embodiments, a provider may be advised to conduct the appropriate assessment as soon as possible after symptoms are reported and/or after a symptom indicating a particular condition is reported. The first episode of care when assessments were conducted is shown within the rightmost circle. FIG. 8C depicts an illustrative graph that may be presented on a dashboard in accordance with embodiments of the disclosure. As seen in FIG. 8D, there is overlap between symptom episodes and assessment episodes, which may indicate to the provider that the patient continued to experience symptoms while they were going through a series of assessments.

FIGS. 8E and 8F depict versions of an illustrative graph that may be presented on a dashboard in accordance with embodiments of the disclosure. The vertical axis corresponds to episode code numbers, and the horizontal axis corresponds to the occurrences of events (e.g., episodes, diagnoses, etc.), in which the “Care Pathway Episode Number” refers to the sequential occurrence of care pathway episodes. In embodiments, the horizontal axis may correspond to time and/or date. The illustrative graph depicted in FIG. 8E shows a full set of episodes of care across a pathway for an AF patient. The circles indicate interventions. In this case, the first circle at episode 18 represents a cardioversion (I1) received by the patient and the second circle represents a Left Atrial Appendage Occlusion (LAAO) (I4) procedure that took place. The four crosses represent episodes when medication was prescribed in an effort to manage the patient's condition. In these cases, rhythm control medication was prescribed (M2). In FIG. 8F, links between certain episodes of care are shown. During episode 7, the patient presented with two symptoms leading to a doctor suspecting AF. The doctor ordered testing for the patient. Two tests were conducted during episode 10 resulting in the patient being given a diagnosis of AF at episode 11.

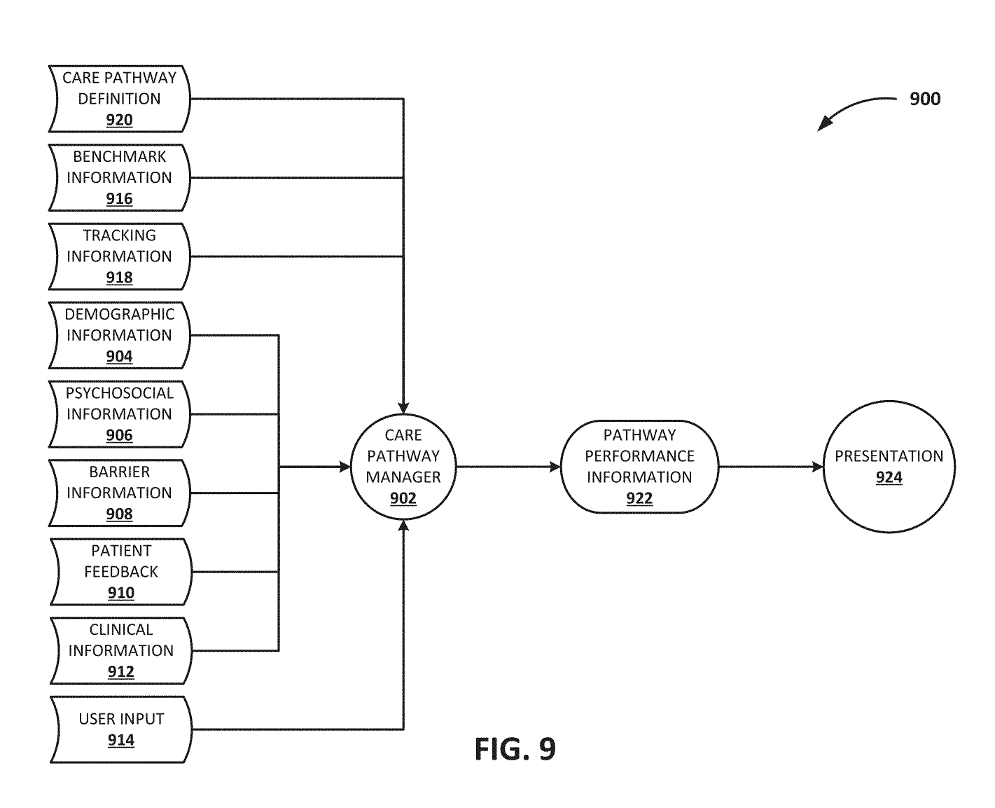

As described above, any number of various combinations of components depicted in FIG. 3 may be implemented in any number of different ways, on any number of different devices, and/or the like. FIG. 9 is a schematic diagram depicting an illustrative process flow 900 for facilitating management of care pathways, in accordance with embodiments of the disclosure. Because any number of the various components depicted in FIG. 9 may be implemented in any number of different combinations of devices, FIG. 9 is depicted, and described, without regard to the particular device(s) within which each component is implemented, but is rather discussed in the context of system components and their functions.

As shown in FIG. 9, a care pathway manager 902 receives, as input, patient information. That patient information may include, for example and as shown, demographic information 904, psychosocial information 906, barrier information 908, patient feedback 910, and clinical information 912. The care pathway manager 902 also may receive user input 914, benchmark information 916, tracking information 918, a care pathway definition 920, and/or the like. Based on at least the patient information (and, in embodiments, the user input 914, the benchmark information 916, the tracking information 918, and/or the care pathway definition 920), the care pathway manager 902 determines pathway performance information 922. The pathway performance information 922 may include and/or be based on one or more care metrics. According to embodiments, any number of additional types of information may be used by the care pathway manager 902 in determining pathway performance information 920. For example, in embodiments, the care pathway manager 902 may also receive operational and/or performance data from hospitals or other healthcare providers, health care study information (e.g., results from clinical studies, statistical analyses regarding populations, etc.), public records related to healthcare providers' licenses (e.g., disciplinary reports, records of convictions of crimes, license revocations and/or restrictions, etc.), and/or the like.

In embodiments, determining one or more care metrics may include applying a statistical model to the patient information. The statistical model may include, for example, a regression model, a correlation model, and/or the like. In embodiments, care metrics may be determined using any number of other types of predictive models such as, for example, fuzzy logic, neural networks, graph-based models, classifiers and/or networks of classifiers, and/or the like. In embodiments, care metrics may be determined using healthcare study information. That is, for example, studies, research, and/or clinical trials may be conducted to evaluate the effectiveness of various care pathways. For example, trials can be conducted to compare outcomes for patients that are compliant to a care pathway versus patients that are non-compliant to determine the influence of compliance on outcomes. In other examples, trials can be conducted to compare outcomes for patients on different care pathways, for care pathways having different care pathway steps, and/or the like. Additionally or alternatively, care metrics may be determined by analyzing historical information obtained from medical records, healthcare provider operations/performance information, and/or the like.

The care pathway manager 902 may provide the pathway performance information 922 to a presentation task 924. The presentation task 925 may include causing a display device to present a representation of the pathway performance information 922. According to embodiments, presenting a representation of the pathway performance information 922 may also include presenting a representation of one or more care metrics, a care pathway, and/or the like. The presentation task 924 may be performed, for example, by a processor that causes a display device to present the representations.

Additionally, the process 900 may be a cyclical process. That is, for example, the care pathway manager 902 may receive additional patient information 904, 906, 908, 910, and/or 912, and/or user input 914, and may use that additional information to update the pathway performance information 922 and/or the care pathway definition 920. The presentation task 924 may include presenting a representation of the updated pathway performance information 922 (and/or a representation of the updated care pathway definition 920), which may include presenting a dashboard having one or more representations of care metrics.

The illustrative process flow 900 shown in FIG. 9 is not intended to suggest any limitation as to the scope of use or functionality of embodiments of the present disclosure. Neither should the illustrative process flow 900 be interpreted as having any dependency or requirement related to any single component or combination of components illustrated therein. Additionally, various components depicted in FIG. 9 may be, in embodiments, integrated with various ones of the other components depicted therein (and/or components not illustrated), all of which are considered to be within the ambit of the present disclosure.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A method of facilitating management of a care pathway, the method comprising:
receiving user input comprising a first step identification (ID) code and a second step ID code, the first step ID code corresponding to a first care pathway step and the second step ID code corresponding to a second care pathway step;
constructing a care pathway structure based on the first and second care pathway steps;
determining a first keyword associated with the first care pathway step and a second keyword associated with the second care pathway step;
receiving, from an information source, patient information associated with a patient;
identifying, based on the first keyword and the patient information, a first care episode;
identifying, based on the second keyword and the patient information, a second care episode;
extracting, from the patient information, a first set of episode information corresponding to the first care episode and a second set of episode information corresponding to the second care episode;
associating the first and second care episodes with the first and second care pathway steps, respectively;
determining, based on the care pathway definition and the first and second sets of episode information, a care metric; and
causing a display device to present a representation of the care metric.

2. The method of claim 1, the patient information comprising clinical information and at least one of psychosocial information, experiential information, relational information, preferential information, demographic information, barrier information, and compliance information.

3. The method of claim 1, further comprising generating, based on the care metric, a recommendation, the recommendation comprising at least one of a care recommendation and a care pathway definition recommendation.

4. The method of claim 3, further comprising:
determining that the first and second care episodes are linked; and
associating a link identifier with each of the first and second care episodes, the link identifier indicating that the first and second care episodes are linked;
wherein the care metric is determined based in part on the fact that the first and second care episodes are linked.

5. The method of claim 4, the recommendation comprising the care recommendation, wherein the care recommendation comprises a recommendation to associate the patient with a third care pathway step.

6. The method of claim 5, further comprising:
receiving user input comprising an indication of a first weighting and an indication of a second weighting; and
associating, based on the user input, the first weighting with a third care pathway step; and
associating, based on the user input, the second weighting with a fourth care pathway step;
wherein generating the care recommendation comprises determining that the first weighting is greater than the second weighting.

7. The method of claim 3, the recommendation comprising the care pathway definition recommendation, wherein the care pathway recommendation comprises a suggested amended care pathway definition.

8. The method of claim 1, further comprising generating a report, the report comprising at least one of care pathway compliance information, care variability information, and financial information associated with the care pathway definition.

9. A system for facilitating management of a care pathway, the system comprising:
a display device;
at least one processor; and
one or more computer-readable media having computer-executable instructions embodied thereon that, when executed by the at least one processor, cause the at least one processor to instantiate at least one program component, the at least one program component comprising a care pathway manager configured to:
receive a care pathway definition, the care pathway definition comprising a first care pathway step and a second care pathway step, wherein the first care pathway step is identified by a first step identification (ID) code, and wherein the second pathway step is identified by a second step ID code;
identify, based on searching patient information for a first keyword associated with the first step ID code and a second keyword associated with the second step ID code, a first care episode and a second care episode, respectively;
extract, from the patient information, a first set of episode information corresponding to the first care episode and a second set of episode information corresponding to the second care episode;
associate the first and second care episodes with the first and second care pathway steps, respectively;
determine, based on the care pathway definition and the first and second sets of episode information, a care metric; and
cause the display device to present a representation of the care metric.

10. The system of claim 9, the patient information comprising clinical information and at least one of psychosocial information, experiential information, relational information, preferential information, demographic information, barrier information, and compliance information.

11. The system of claim 9, wherein the care pathway manager is further configured to generate, based on the care metric, a recommendation, the recommendation comprising at least one of a care recommendation and a care pathway definition recommendation.

12. The system of claim 11, the recommendation comprising the care recommendation, wherein the care recommendation comprises a recommendation to associate the patient with a third care pathway step.

13. The system of claim 12, wherein the care pathway manager is further configured to:
determine that the first and second care episodes are linked; and
associate a link identifier with each of the first and second care episodes, the link identifier indicating that the first and second care episodes are linked;
wherein the care metric is determined based in part on the fact that the first and second care episodes are linked.

14. The system of claim 12, wherein the care pathway manager is further configured to:
receive user input comprising an indication of a first weighting and an indication of a second weighting; and
associate, based on the user input, the first weighting with a third care pathway step; and
associate, based on the user input, the second weighting with a fourth care pathway step;
wherein the care pathway manager generates the care recommendation in part by determining that the first weighting is greater than the second weighting.

15. The system of claim 11, the recommendation comprising the care pathway definition recommendation, wherein the care pathway recommendation comprises a suggested amended care pathway definition.

16. A method of facilitating management of a care pathway, the method comprising:
receiving a first stage identification (ID) code and a second stage ID code, the first stage ID code corresponding to a first care pathway stage and the second stage ID code corresponding to a second care pathway stage;
receiving a first step ID code and a second step ID code, the first step ID code corresponding to a first care pathway step and the second step ID code corresponding to a second care pathway step;
constructing a care pathway structure by:
establishing a care pathway trajectory defining an intended chronological order associated with the first and second care pathway stages;
associating the first care pathway step with the first care pathway stage; and
associating the second care pathway step with the second care pathway stage;
determining a first keyword associated with the first care pathway step and a second keyword associated with the second care pathway step;
receiving, from an information source, patient information associated with a patient;
identifying, based on the first keyword and the patient information, a first care episode;
associating a first care episode code with the first care episode;
identifying, based on the second keyword and the patient information, a second care episode;
associating a second care episode code with the second care episode;
extracting, from the patient information, a first set of episode information corresponding to the first care episode and a second set of episode information corresponding to the second care episode;
associating the first and second care episodes with the first and second care pathway steps, respectively;
determining, based on the care pathway definition and the first and second sets of episode information, a care metric; and
causing a display device to present a representation of the care metric.

17. The method of claim 16, further comprising:
generating an episode timeline that indicates a temporal relationship between the first care episode and the second care episode;
determine that the first and second care episodes are linked; and
associate a link identifier with each of the first and second care episodes, the link identifier indicating that the first and second care episodes are linked;
wherein the care metric is determined based in part on the episode timeline and the fact that the first and second care episodes are linked.

18. The method of claim 16, further comprising generating, based on the care metric, a recommendation, the recommendation comprising at least one of a care recommendation and a care pathway definition recommendation.

19. The method of claim 18, the recommendation comprising the care recommendation, wherein the care recommendation comprises a recommendation to associate the patient with a third care pathway step, the method further comprising:
receiving user input comprising an indication of a first weighting and an indication of a second weighting; and
associating, based on the user input, the first weighting with a third care pathway step; and
associating, based on the user input, the second weighting with a fourth care pathway step;
wherein generating the care recommendation comprises determining that the first weighting is greater than the second weighting.

20. The method of claim 18, the recommendation comprising the care pathway definition recommendation, wherein the care pathway recommendation comprises a suggested amended care pathway definition.
